(19) United States
(12) Patent Application Publication
(10) Pub. No.: US 2015/0048622 A1
(43) Pub. Date: Feb. 19, 2015

(54) DEVICE AND METHOD FOR GREEN STORAGE OF RECOVERABLE ELECTRIC ENERGY WITH HIGH OVERALL EFFICIENCY

(71) Applicant: Robert Schegerin, Chevilly-larue (FR)

(72) Inventor: Robert Schegerin, Chevilly-larue (FR)

(73) Assignee: VRASTAL, Paris (FR)

(21) Appl. No.: 14/374,981

(22) PCT Filed: Feb. 7, 2013
(86) PCT No.: PCT/FR2013/000038

§ 371 Date: Jul. 28, 2014

(30) Foreign Application Priority Data
Feb. 24, 2012 (FR) 1200551

(51) Int. Cl. F03G 3/00; H02K 7/18

(52) U.S. Cl. CPC F03G 3/00; H02K 7/1853
USPC 290/1 R; 290/7

(57) ABSTRACT

A reliable, eco-friendly, and reactive device for storing large amounts of recoverable energy with high overall energy efficiency enables the electrical energy on a grid to be collected when there is an abundant amount of available electrical energy on the grid, and redistributes the electrical energy to the grid when the electrical energy is running out. The device mainly includes a compact, dense ballast, the ballast having a matching hydrodynamic and aerodynamic shape, and a flow cavity suitable for holding energy corresponding to the maximum energy of the ballast in the cavity, the ballast being capable of moving along the main axis of flow in the cavity, the device further including an energy collection and recovery element and a control element. A braking coefficient and a safety factor are defined and adjusted on the basis of the nature of the movement of the ballast in the flow cavity.

The present invention relates to a device and a method for green storage of electric power used to collect and store electric energy from a network, and then redistribute this energy to the network when needed in order to balance supply and demand.

The purpose of this invention is mainly the collection, storage and release of electric energy.

It also relates more particularly to the storage of energy in form of gravitational potential energy and the release of kinetic energy and gravitational potential energy resulting from the loss of altitude of a weight.

It notably applies to the storage and supply of large amounts of electric energy in a relatively short time.

In addition, it is perfectly suitable for power supply to compensate for electric peak consumption.

It also concerns more particularly a device for storing potential energy of a weight with high efficiency using a circulation cavity resisting shocks generated by a weight in said cavity while preventing these shocks from disturbing the environment for which the device is designed, especially a possible earthquake or destruction of equipments.

The invention more particularly relates to the storage of gravitational potential energy.

Nowadays, electric energy is used almost everywhere, in all fields. Electric energy requirements are steadily growing year by year. Users are not limited in the use of electricity, involving widely varying demands. Consumption peaks appear and are very difficult to be covered by the existing means. Moreover renewable energies are a random resource without any connection with the need.

Energy storage is then a key issue that becomes more and more significant.

For states, energy independence is strategic and necessary on an economic level. For people, communities and companies, energy available on request, stable and without unexpected cut is also essential.

Even for an electric energy producer, storage may be of prime necessity. In fact, what is commonly and economically known as ‘energy production’ is not really a production from a physical point of view, but a conversion of a primary stock of energy, accumulated in a stable physical form (coal, water stored in height, fissile material, etc.), into an energy that can be directly distributed to the electric network.

Thus the invention proposes a storage which involves the creation of a stock of gravitational potential energy from energy that will not be used immediately. The purpose is to be capable of using it later on when the demand is higher. This is particularly essential when the immediately available energy varies with time like intermittent renewable energies (solar, wind) or during peak consumption.

The energy storage operation is always associated with the reverse operation of retrieving the stored energy (withdrawal). Both storage/withdrawal operations generate a storage cycle. At the end of a cycle, the storage system returns to its initial state (ideally “energy-loaded”). The stock has then been regenerated. The overall efficiency of a cycle is the ratio of the amount of retrieved energy to the amount of energy that we initially tried to store. Actually, each of storage and withdrawal operations always leads to energy loss. A portion of the initial energy is not really stored and a portion of the stored energy is not really retrieved. The efficiency of an energy storage cycle greatly depends on the storage nature and physical processes implemented to ensure storage and withdrawal operations.

Storage is directly linked to how we use energy.

Since combustion is the most common usage of energy, storage of fuels is also the most developed. All the states have strategic oil stocks. Even, excluding these fossil elements, we must remember the practical importance of wood energy, where stocks are made for winter, and the development of biofuels.

Long before the discovery of fossil fuels, there were already available forms of energy storage, such as firewood, peat briquettes, hydraulic dams, to meet the needs at any time of the day, all year long.

Storage in form of hydraulic potential energy (by upwelling above the dams when too much electricity is produced) is already used to control and balance electric networks. This solution improves the balance between supply and demand and the availability of renewable energies. Unfortunately the existing solutions have a low overall efficiency and a response time exceeding several tens of minutes.

On a smaller scale, energy storage for electricity production (electrochemical in batteries and accumulators, electric in capacitors) is much smaller in terms of amount of stored energy, but allows development of high power in a very short time.

Heat can be stored too. Beyond the use of a cumulus, houses with a high thermal inertia (thick walls, good insulation) smooth daily temperature variations and reduce the need for heating and air conditioning, involving direct savings.

Another form of thermal storage is the use of phase-change materials in buildings or individual solar water heaters to store thermal solar energy. The phase-change materials smooth the energy provided by the sun (free) and increase the storage capability due to their high volumic energy density. On an industrial scale, sun heat can be stored in tanks prior to electricity production to smooth the solar gain; this kind of use provides small volumes, but it is an interesting way of research in the context of an electric generation by a solar thermal power system.

The mechanical storage is often necessary in engines, as a flywheel, to control the movement at very short periods of time smaller than a second. It is practically not used for long-term storage, because the amount of energy stored is too small.

There are also flywheels rotating at high speed in a cavity where the vacuum is made.

Nowadays, with the appearance of new technologies, there are numerous technologies for storing recoverable energy. Despite the advantages of these existing technologies, they all have drawbacks. Some of them are mentioned below:
rechargeable batteries are relatively expensive in terms of carrying cost, because they must be charged regularly and replaced after a limited number of charging/discharging cycles; they have a detrimental effect on the environment;
capacitive systems that cannot store a large amount of energy;
the so-called “flywheel” systems with limited capacity and using high tech components that make these systems relatively expensive, especially if we compare the purchasing cost with the power supplied;
air-operated systems yielding a too low efficiency;
hydraulic systems composed of pumps, turbines and storage tanks, with very low efficiency too.

When we talk about the generalized development of renewable energies, we are facing criticism about the intermittence of sun and wind. Actually, there is no denying that solar and wind energies may be zero on a winter evening with no wind, at the time of peak consumption.

We also know the document FR 2 929 659 which describes a mechanical device for storing energy during unlimited time including a weight attached to a shaft which lifts or lowers the weight when it is rotating. Unfortunately this device is not fitted with a circulation cavity in which the weight can move freely.

The publication US 201 10241354 describes a storage device for potential energy comprising a least a weight of 1 ton minimum that can move within a cavity, preferably a curved cavity, particularly a drilling well, while avoiding a jam of the weight on the walls of said cavity, which contains liquids such as water or oil.

We know documents WO 2009100211 and DE 10037678, each presenting a device and a method for storing the gravitational potential energy of a useful weight for storing energy produced during off-peak hours and/or energy generated from renewable resources, such as wind and sun, or for moving objects in depth that can operate on earth and in an aquatic environment, especially in a mine shaft or in the sea. These storage devices comprise a weight made of a dense material of at least 100 tons, hung by a link such as a cable. This weight can move under the influence of gravity in a cavity along a vertical or inclined axis, from a first lift position to a second lift position, on a distance of at least 200 meters. These storage devices also comprise an electric power generator and controls coupled with an operator dedicated to operate the link in order to securely move the weight; thus electricity is provided to the network when the weight moves from the first lift position to the second lift position, converting gravitational potential energy into electric power when required by the network and then converting electric power from the network into gravitational potential energy when the electric power of the network is abundant and available.

We also know the document WO 2010/049492 presenting an electromechanical energy storage device that stores energy from renewable energy sources depending on the needs of the network. This device is electrically connected to an energy source. This device includes a weight of mass between 500 and 1,000 tons that can move on a distance of 100 meters minimum and store energy. It also comprises an electric generator, an electric motor and control means coupled with an operator. Like in the documents mentioned above, this device provides electricity to the network when the weight moves from the first lift position to the second lift position, by converting the gravitational potential energy into electric power when required by the network and converting the electric power from the network into gravitational potential energy when the electric power of the network is abundant and available.

The devices and methods mentioned above, i.e. documents US 2011/0241354, WO 2009/100211, DE 10037678 and WO 2010/049492 provide a solution on how to store energy, especially in form of gravitational potential energy, by delivering energy to compensate for power peak consumption. Unfortunately these devices and associated methods have the following major drawbacks:
Potential landslide and/or earthquake due to wrong or inadequate functioning of the device, characterized by a lack of optimal safety means designed to provide sufficient and necessary safety conditions so that the cavity can withstand a shock of high energy corresponding to free fall or shock of the weight against the walls of the cavity. Indeed, since the mass of the weight is heavy and the cavity structure is not defined, a malfunction and/or excessive speed and/or when approaching the lower part or walls of the cavity would cause full destruction of the storage device. Such drawbacks may result in an earthquake in the region where the storage device is used, and involve harmful consequences for surrounding structures and/or said storage device, thus paralysing these energy storage devices which would become unusable. Thus, in case one or more cables hanging the weight break, two critical consequences can be identified, i.e. destruction of the device and propagation of seismic waves resulting from the collision of the weight with the walls of the cavity.
Increase of energy resulting from the fall of the weight in the critical case of malfunction and/or excessive speed and/or when approaching the lower part. Indeed, at considerable depths, a temperature gradient appears between the platform and the inside of the cavity. At 3 meters, this temperature gradient is about 2 degrees Celsius.
The velocity of the fluid within the cavity can be greater than 3 meters per second.
The shape of the weight is not suitable for optimal operation of the device.

Indeed, no special shape is intended for the weight to reduce all kinds of friction forces that may affect its motion, because fluid friction forces can be more or less important depending on the environment. These forces can sufficiently influence the path and/or motion of the weight, which could have adverse effects on the gain of electric power production. In these documents, the weight is rectangular or cylindrical or oblong. This shape is not suitable for an energy storage device moving in a resistive fluid, preferably a viscous fluid, because, for the weight shape defined in the documents mentioned above, the fluid force is ignored and seems to be strong enough to alter the operation of the device and/or gain of production. This means that flat faces and right angles defining the weight take an active part in the braking of the weight when it moves down in the cavity.
The method of operation of the device described in these documents seems to be inappropriate to an operation in a complex and/or heterogeneous environment comprising at least two fluids such as water and air, which represents the usual operating conditions, especially deserted mine shafts. Indeed, the method dealt with in these documents is not defined to operate the device in such configurations, because the method explained is not capable of controlling the movements of the weight in an environment containing at least two fluids with different densities. The movement of the weight would be opposed to fluid friction, making the movement of said weight difficult, which might be harmful to the safety and operation of the device as a whole.
In normal operation, the lowering speed of the weight seems to be too excessive and cannot avoid any inclination or failure of the device. Indeed, in normal operation, the storage device according to document DE 10037678 operates at a speed of 10 m/s. The speed seems excessive because, if the cavity contains at least two fluids F1 and/or F2, fluid friction forces may become too important and interfere with the movement of the weight in the circulation cavity. Therefore, the weight cannot be controlled by the operator.

In the further description, the terms listed below will have the following definition:
Green or environment-friendly: without greenhouse gas emissions.
Hydrodynamic shape: defines the appearance of the shape of an object moving in a fluid and its resistance to forward motion.
Aerodynamic shape: defines the appearance of the shape of an object moving in the air and its resistance to forward motion.
Many-to-one: a relationship where several elements of a set are associated with one and only one element of another set. For example, a pair (x,y) of a set is associated with one and only one element z of the other set.
One-to-many: a relationship where each element of a set is associated with several elements of another set. For example, an element x is associated with the elements y and z of the other set.
Many-to-many: a relationship where several elements of a set are associated with several elements of another set. For example, elements x and t of a set are associated with elements y and z of the other set.

The invention therefore aims at overcoming these drawbacks. More particularly, the purpose of this invention is to provide a device and a method for green storage of recoverable energy with high overall efficiency, that can be used to withdraw electric energy from a distribution network when the electric power is abundant and available on this network, and to redistribute electric power to the network when needed; this network is composed of at least an electric power generator, at least an electric power user and at least a power line.

The invention also provides a secure operating method for the green energy storage device defined by the invention.

One objective of the invention is to propose a device and a method for a secure environment-friendly energy storage, which can completely overcome the drawbacks mentioned and known from prior works.

The purpose of the invention is a green device for storing recoverable energy with high overall efficiency, comprising:
at least a compact and dense weight M, with section S2, having a specific gravity of at least 1, preferably equal to 4, and a mass of at least 10,000 kg,
at least a circulation cavity, defining a mobility range for the weight M; this cavity has a height H of at least 20 meters, a characteristic traveled dimension d of at least 1 m, preferably 3 or 10 m, a section S1 delimiting the internal environment, a lower part P1 forming a bottom, an accessible top part P2 opened to a platform. The cavity has a main axis of displacement YY′ and contains at least one fluid F, at least one cable C linking the weight M to at least one drum T and to at least a first unit comprising a locking and unlocking system of the drum T. This first unit maintains the weight in a stable position inside the cavity or on the platform of said cavity, during a given time and at a given altitude, without loss of potential energy,
at least a second unit including at least an electric motor ME, that converts electric power from the electric supply network into gravitational potential energy by driving the drum T. This second unit will increase the altitude of the weight M when the electric power of the network is abundant and available,
at least a third unit consisting of at least an electric generator GE mechanically connected to the drum T, which both controls velocity of the weight M and supplies the network with the required electric power. This third unit will reduce the altitude of the weight M when the network requires electric power by converting the gravitational potential energy and possibly kinetic energy of the weight M into electric power; the converted gravitational potential energy and possibly kinetic energy will be delivered to the network,
at least a forth unit for measuring the altitude of the weight M, at least when the weight is close to the bottom of the cavity,
at least a fifth control unit in real or delayed time, composed of a computer for controlling the first, second and third units mentioned above, depending on the quantity and availability of the network electric power, the electric energy required by this network and the position of the weight M.

Advantageously, the previously defined cavity can withstand without risk a shock of high energy corresponding to the maximum energy released when the weight M falls in said cavity.

According to other specifications of the invention, the previously defined weight M has an appropriate hydrodynamic or aerodynamic shape so that, in normal operation, hydrodynamic and/or aerodynamic frictions applied to the weight M by the fluid F are generally negligible and allow free circulation of the fluid F in the cavity without disturbing movements of the weight M in said cavity.

The proposed invention brings solutions to the various problems stated before, such as:
use of cheap and available energy resources;
storage of a large amount of energy during a long time without loss of energy;
release of the stored energy with a good overall efficiency during an adaptable period of time, in one or several times;
a great number of possible releases (cycles) covering the needs over a long period of time;
a huge recoverable instantaneous power;
a low installation cost;
a minimum carrying cost for a long period of time (minimum carrying price compared to the recoverable energy and minimum price compared to the maximum recoverable power);
a minimum environmental impact even when dismantling the installation;
reliability against any risk of shock or collision between the weight and the walls or the bottom of the cavity;
delivery of electric power to the network during a peak demand,
consumption of the network power in case of extra power delivered by the network,
smoothing of electric power supplied by renewable energy generators such as wind turbines and solar panels.

Other specifications and advantages of the invention will appear when reading the further detailed description, including the appended drawings to which it should be referred for better understanding; these drawings represent some configurations of this device according to the invention, but examples are not limited.

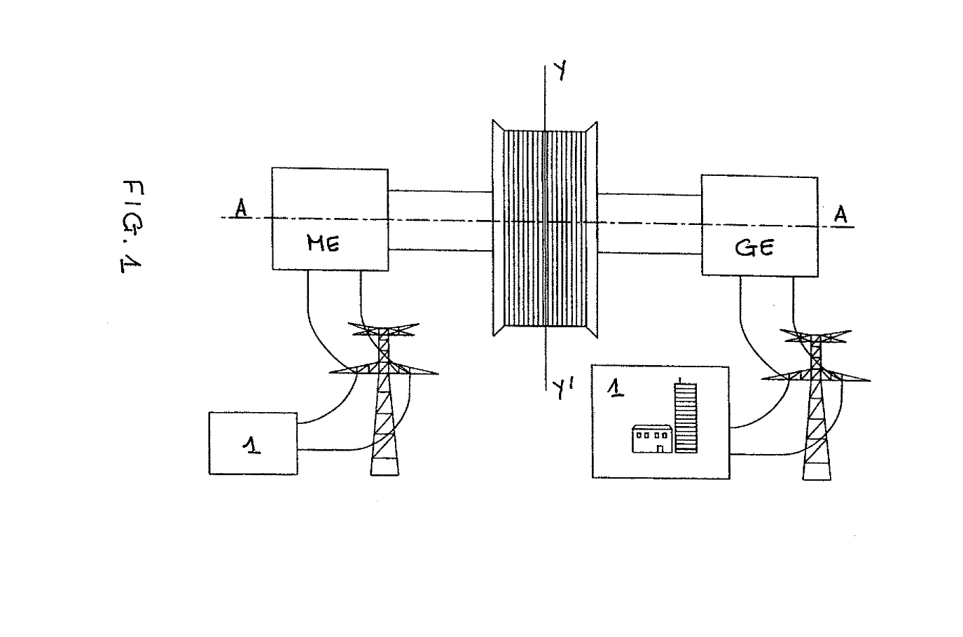

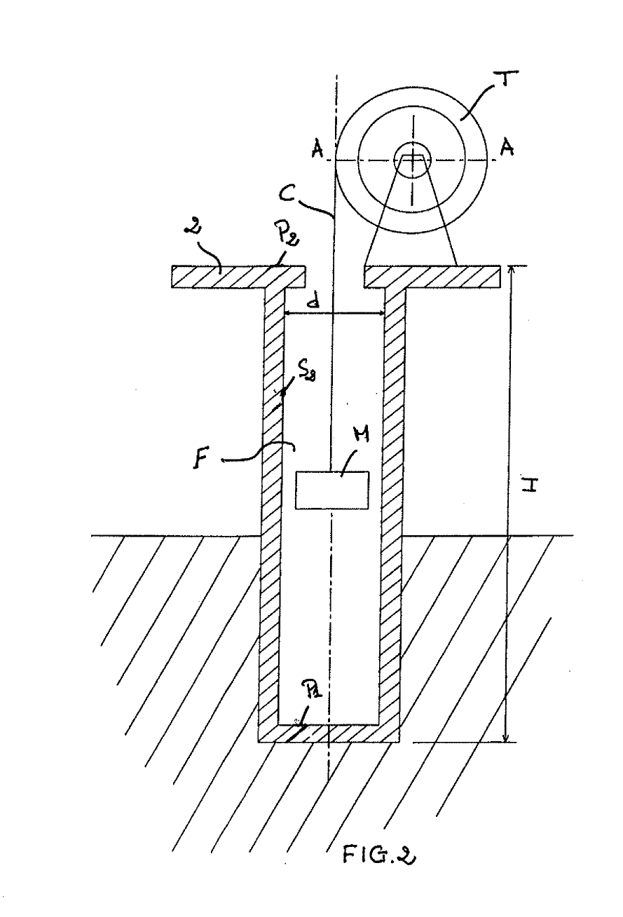

FIG. 1 is a side section A-A of the top part of a first configuration of the device according to the invention;

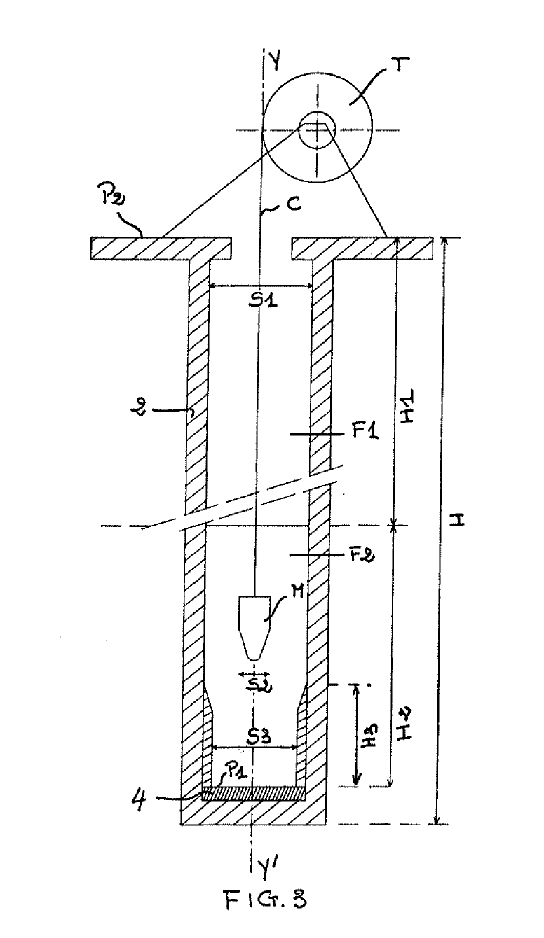

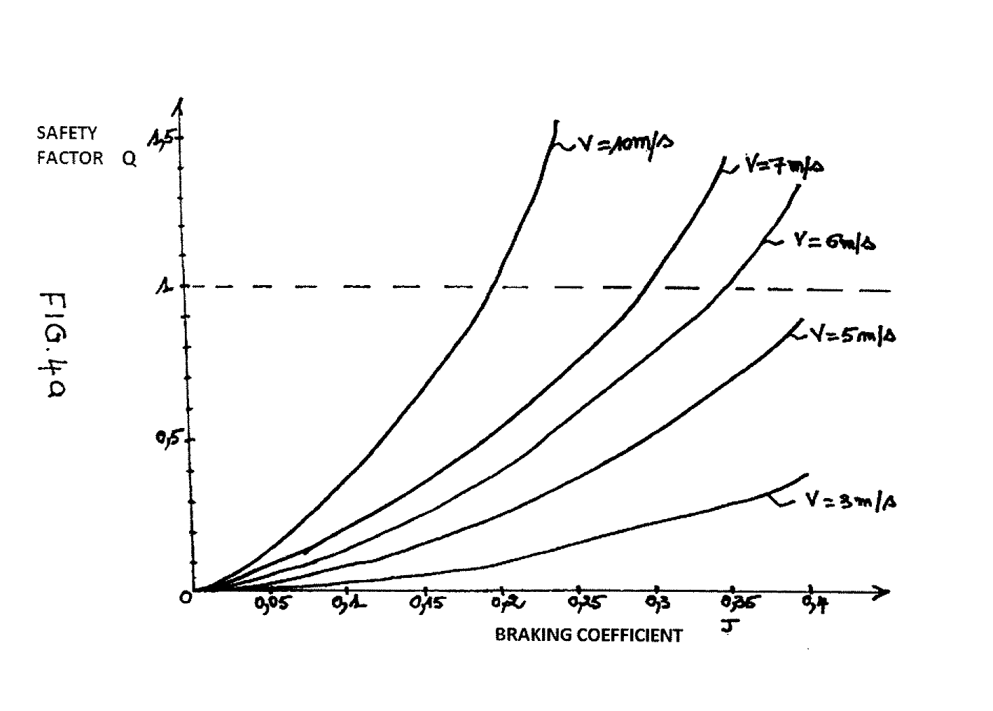

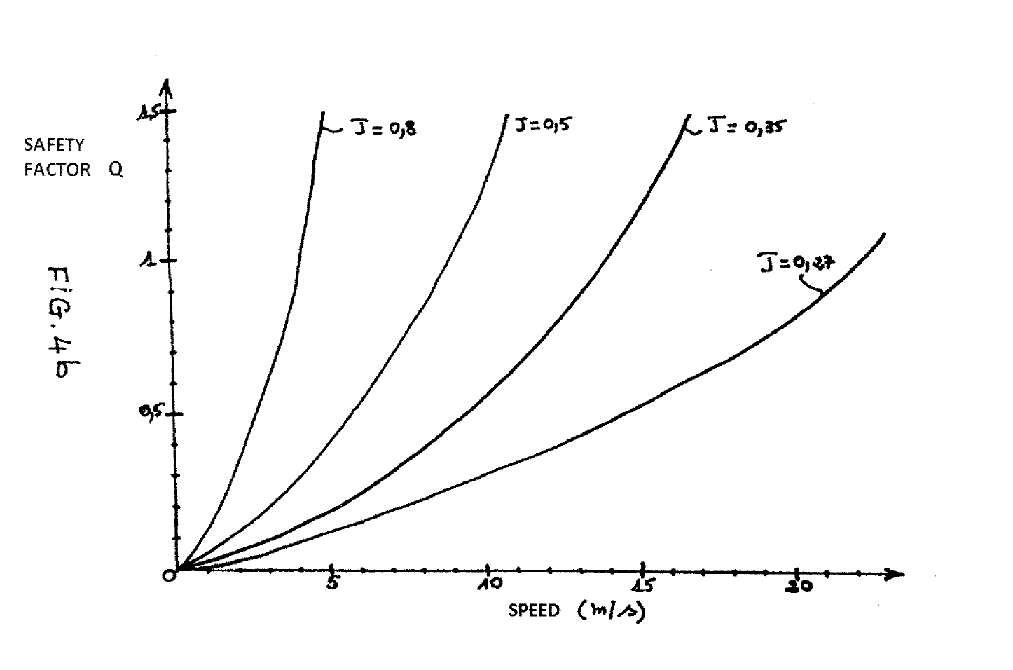

FIG. 2 or FIG. 3 is a longitudinal section of a first preferred configuration of the device according to the invention;

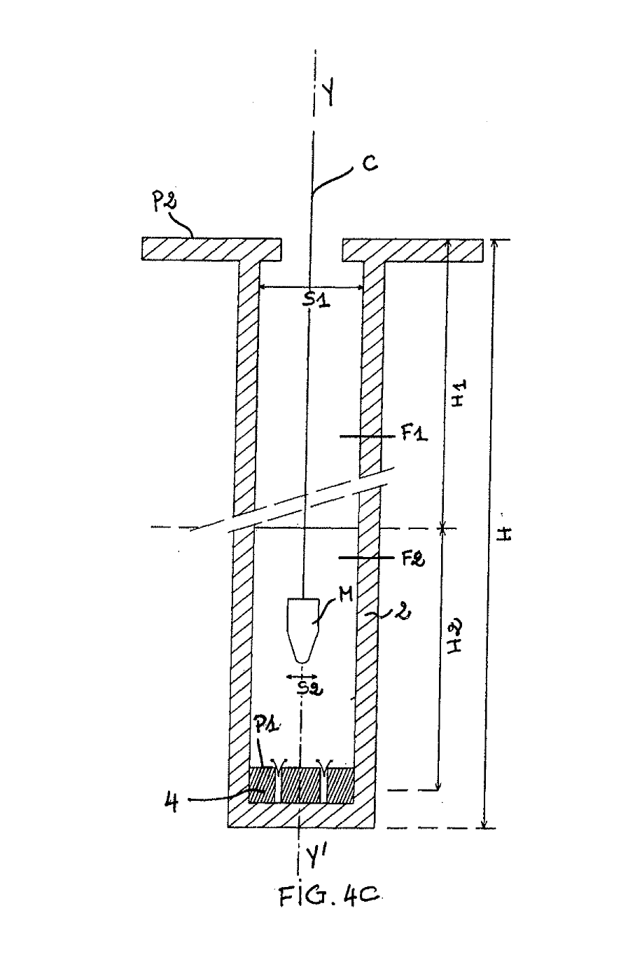

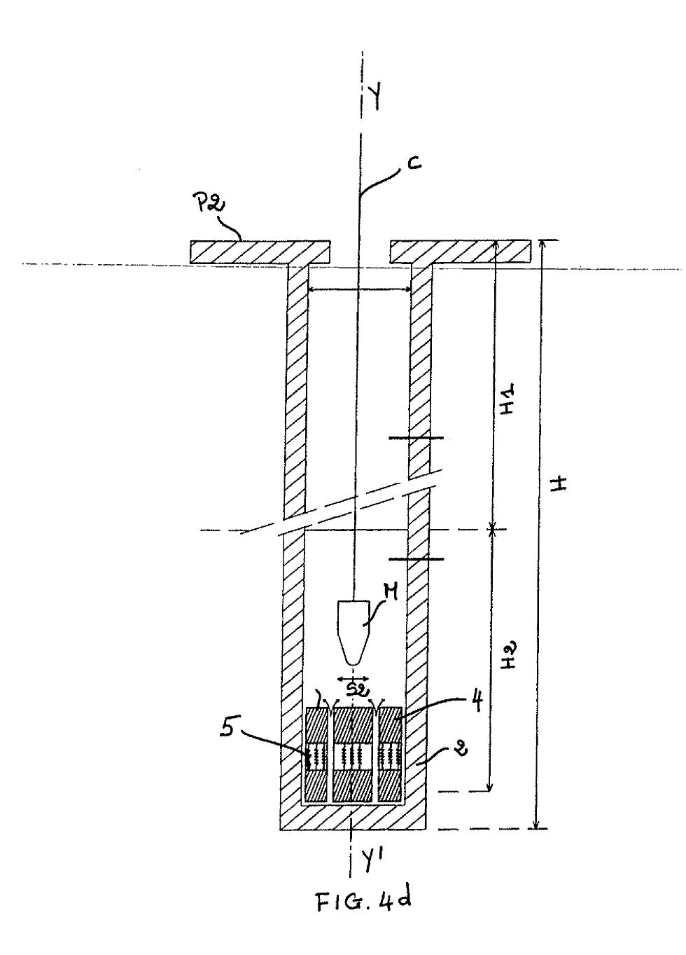

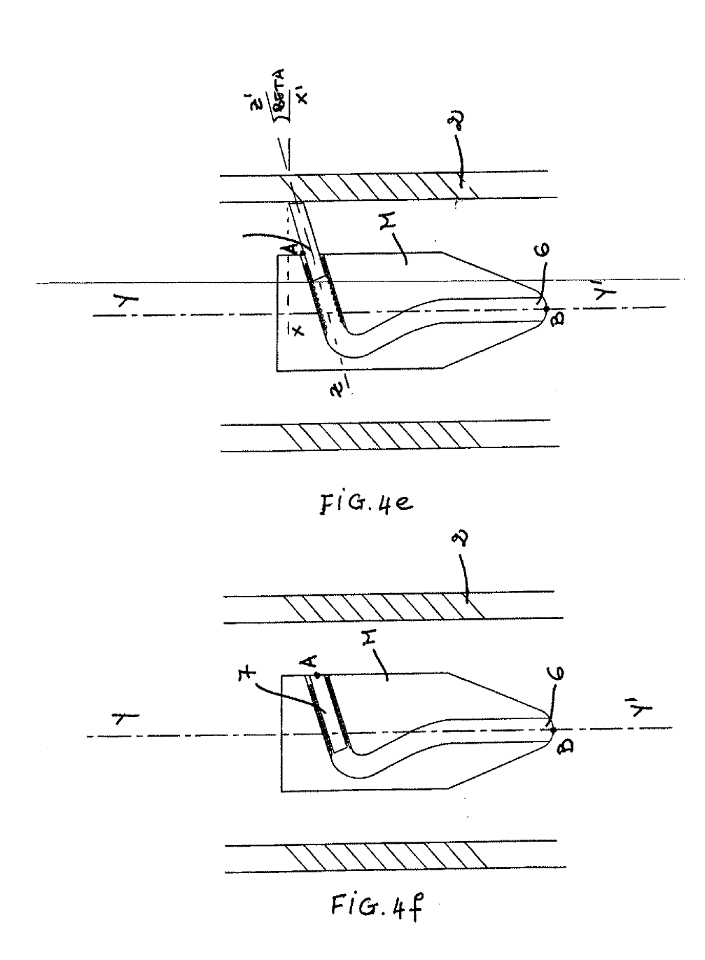

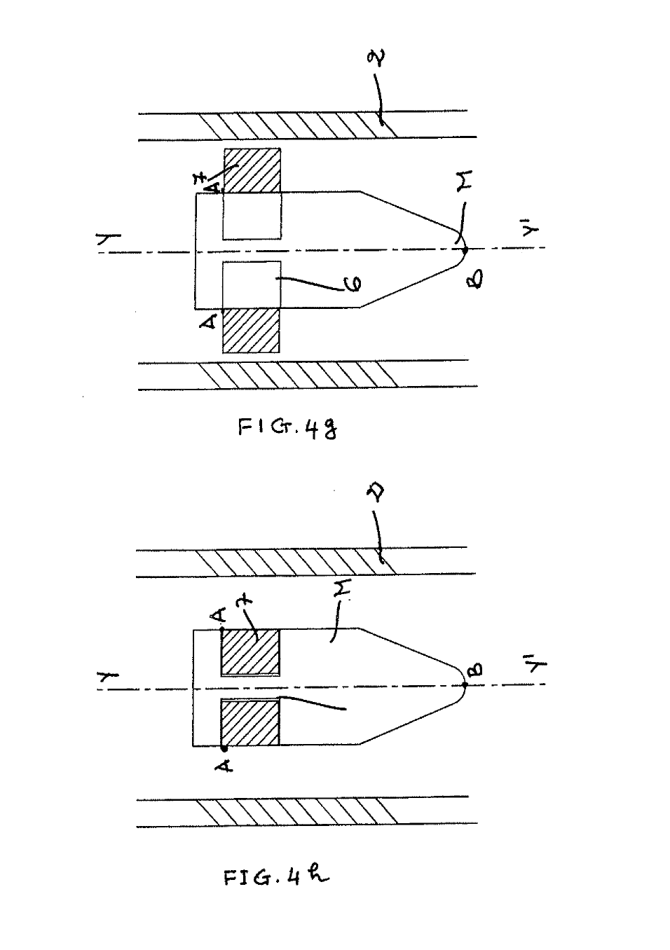

FIG. 4a shows variation curves of the safety factor vs. braking coefficient for different selected values of the weight velocity;

FIG. 4b shows variation curves of the safety factor vs. weight velocity in the circulation cavity for different values of the braking coefficient;

FIG. 4c is a longitudinal section of an alternative of the first preferred configuration of the device according to the invention;

FIG. 4d is a longitudinal section of another alternative of the first preferred configuration of the device according to the invention;

FIG. 4e and FIG. 4f are longitudinal sections of a weight according to the invention;

FIG. 4g and FIG. 4h are alternative longitudinal sections of a weight according to the invention;

FIG. 4i and FIG. 4j are also alternative longitudinal sections of a weight according to the invention;

FIG. 5 is a lowering sequence showing an operating method for the energy storage device according to the invention;

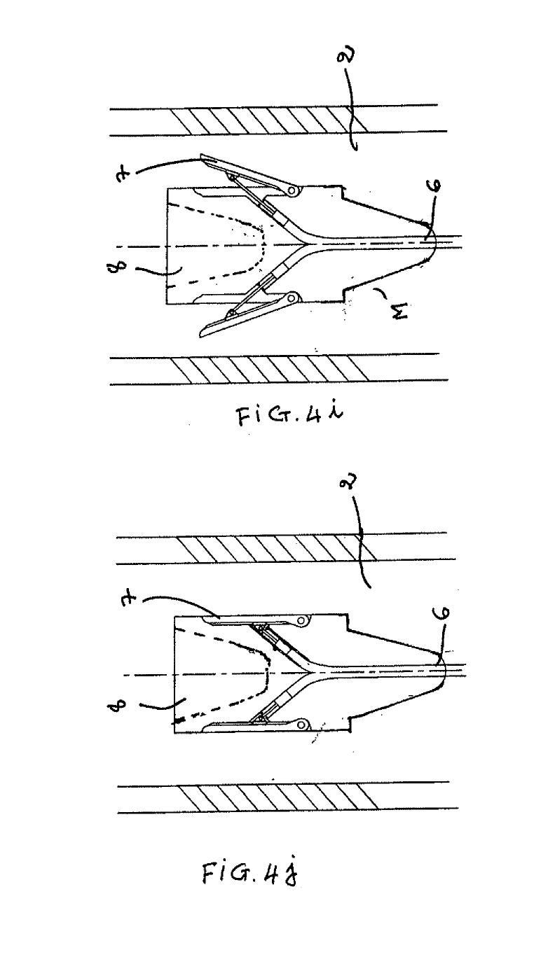

FIG. 6a or 6b is a longitudinal section of a second preferred configuration of the device according to the invention;

FIG. 6c is a longitudinal section of an alternative of the first and second preferred configurations of the device according to the invention;

FIG. 6d is a longitudinal section of another alternative of the first two preferred configurations of the device according to the invention;

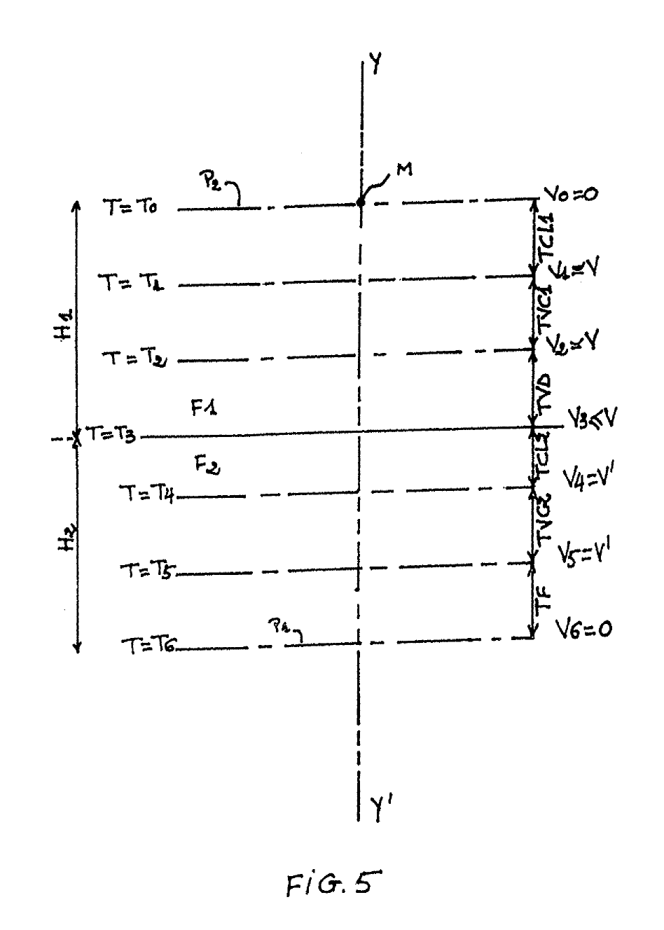

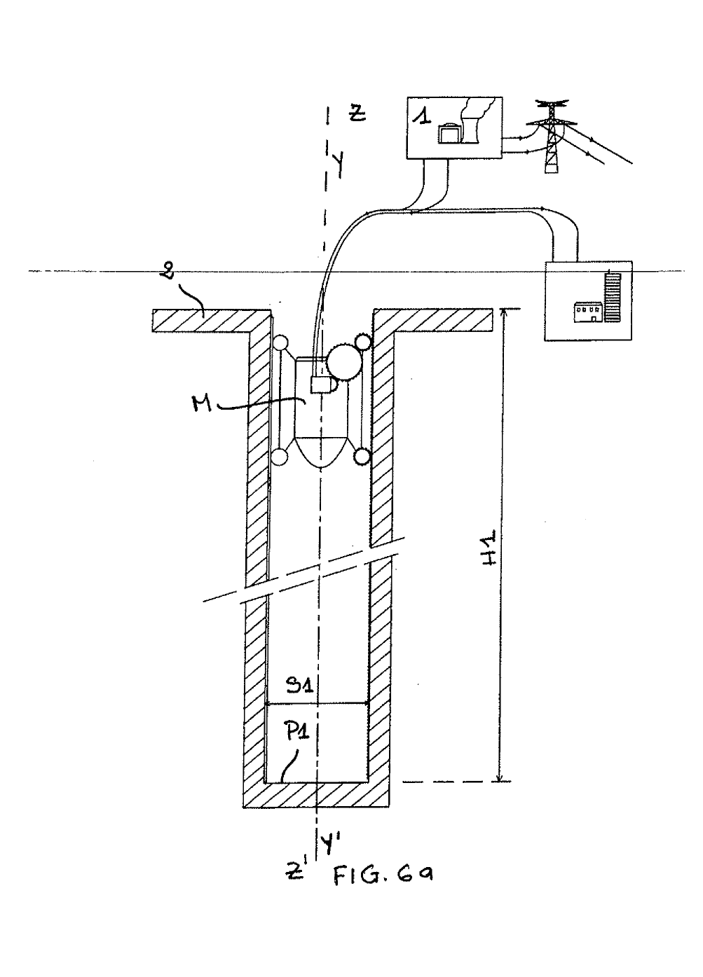

FIG. 7 is a longitudinal section of a third preferred configuration of the device according to the invention;

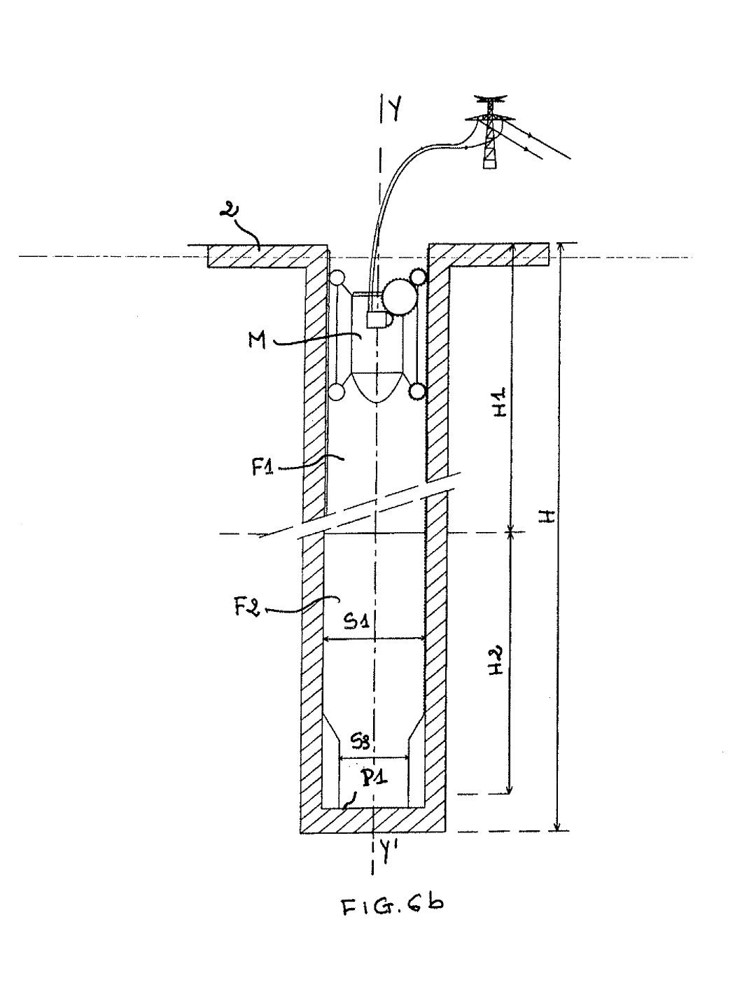

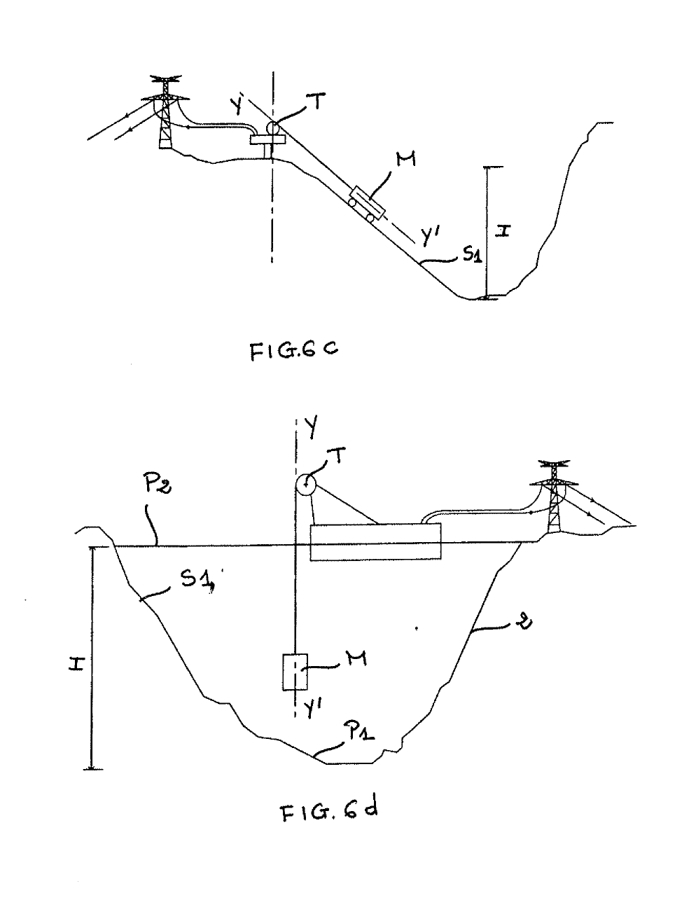

FIG. 8 is a longitudinal section of a forth preferred configuration of the device according to the invention;

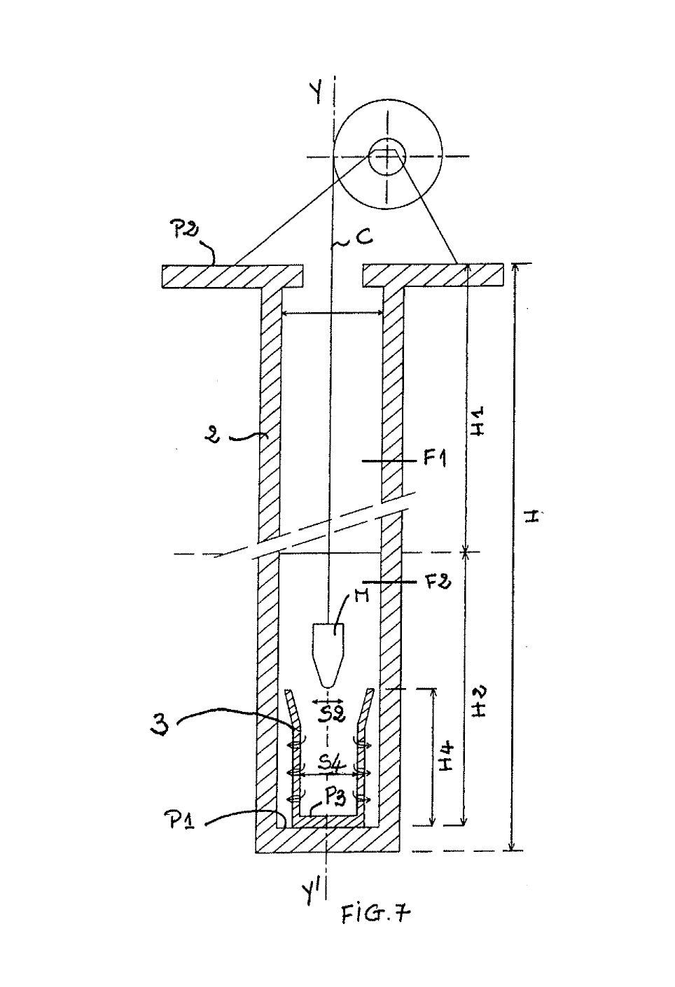

FIG. 9 is a longitudinal section of a fifth preferred configuration of the device according to the invention;

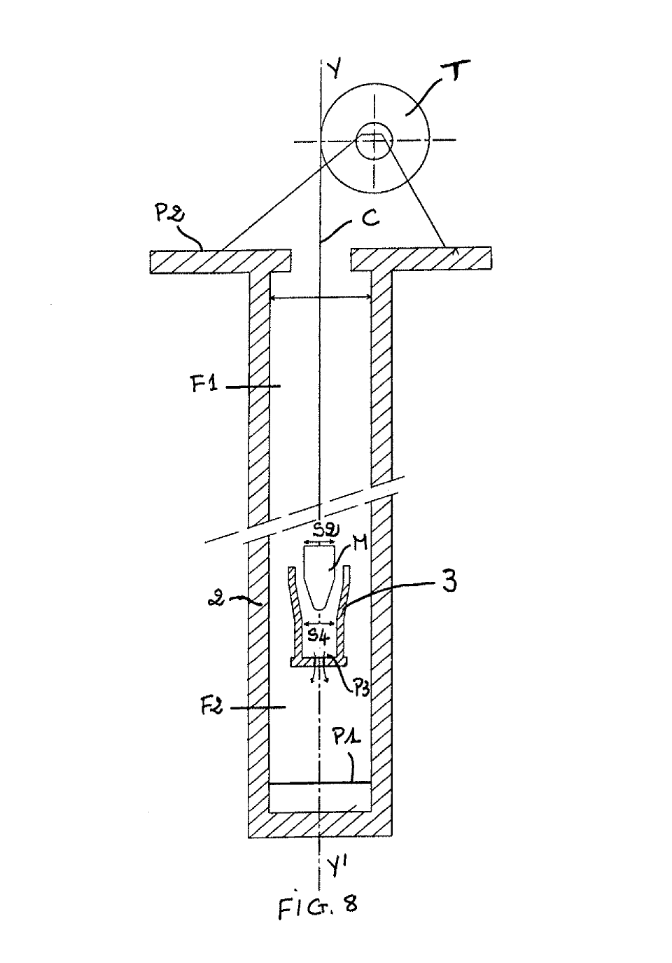

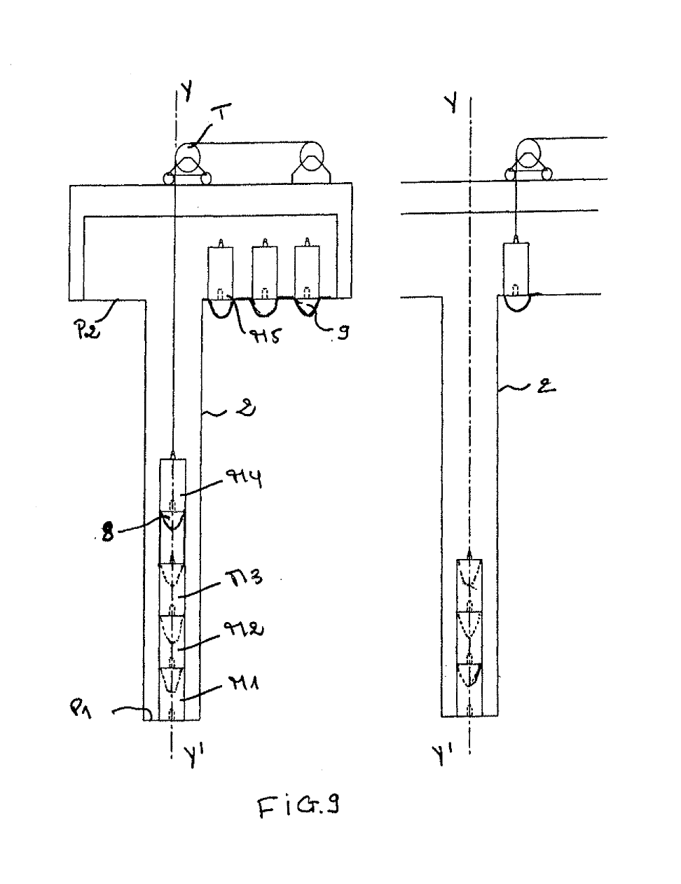

FIG. 10 is a cross section of a sixth preferred configuration of the device according to the invention;

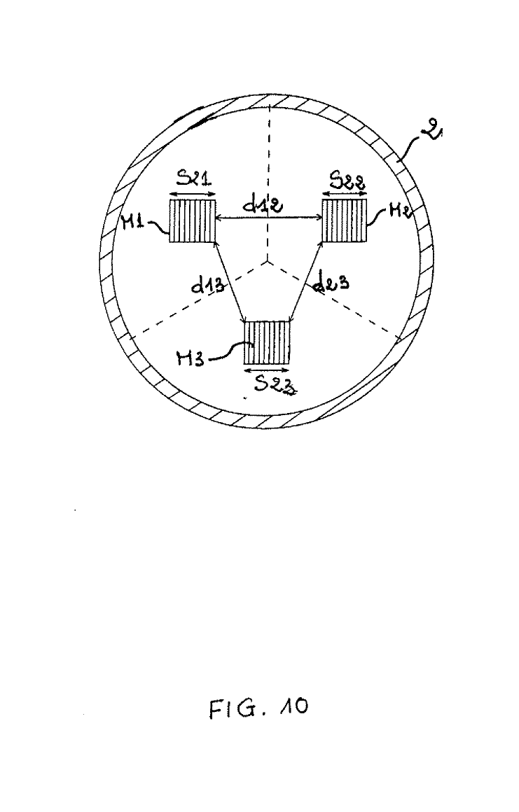

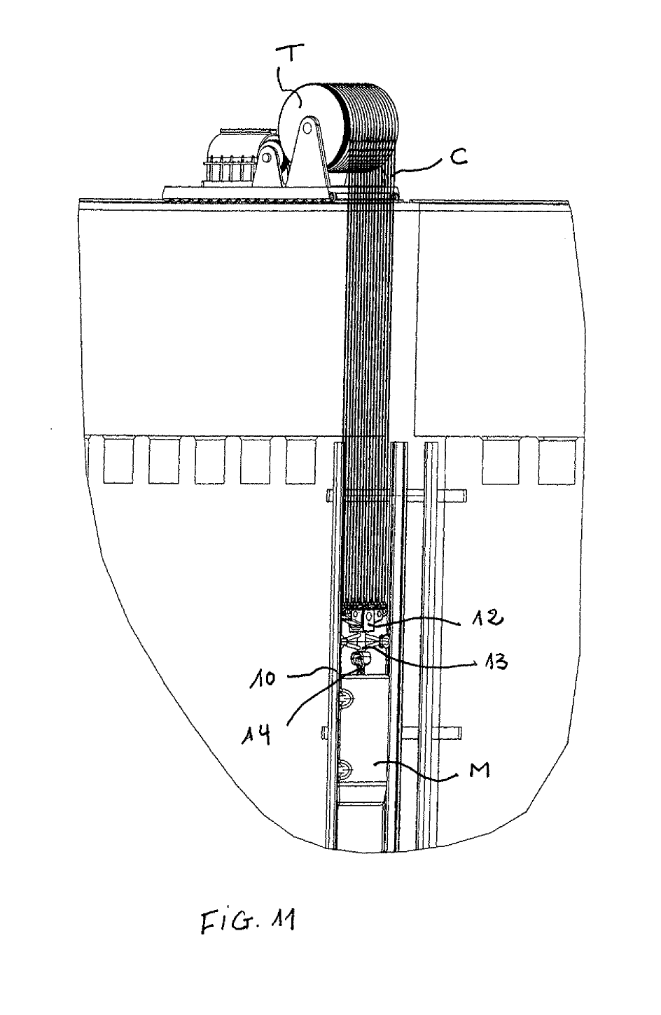

FIG. 11 is a longitudinal section of an alternative configuration of the device according to the invention;

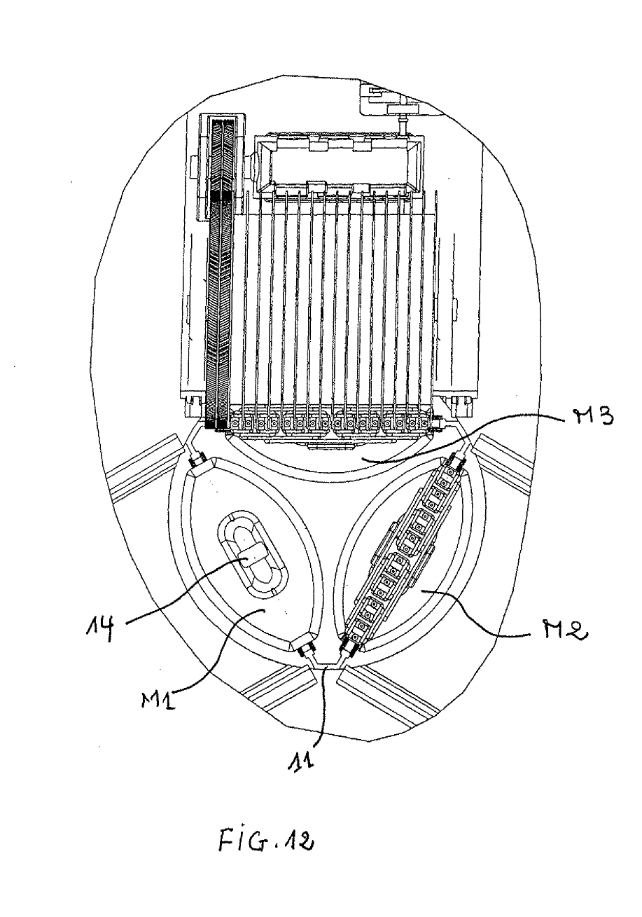

FIG. 12 is a cross section of an alternative configuration of the device according to the invention.

Referring to FIG. 1 which is a section A-A of the top part of the first configuration of the device according to the invention, the device comprises an electric motor ME which takes electric power from a distribution network (1) when the electric power is abundant and available on this network (1); this energy is stored in the storage device. The energy is then redistributed by an electric generator GE to the network (1) or possibly to another power grid when required by the network or the power grid. This device is environment-friendly, because it does not emit greenhouse gases.

FIG. 2 or FIG. 3 shows an energy storage device according to the first configuration of the storage device defined by the invention. In this non-limiting example of an energy storage device according to the invention, the device includes at least a compact and dense weight M, of section S2. This weight has a relative density with respect to water of at least 1 in order to store a great mass in a small volume. The selected weight has a mass of at least 10,000 kg. It is made of dense materials such as carbon steel, tungsten steel, stainless steel, bronze, cement, diamond, iron, brass, mercury, nickel, gold, titanium, zinc, platinum. Preferably the density of the weight with respect to water is about 5.

According to the invention, the weight can move in a circulation cavity (2) along an axis YY′, so that this circulation cavity defines a mobility range for the weight M. The cavity (2) has a height H of at least 20 meters, a characteristic traveled dimension d of at least 1 m, preferably 10 m, an area S1 delimiting the internal environment, a lower part P1 forming a bottom, an accessible top part P2 opened to a platform P2. The cavity's characteristic traveled dimension d depends on two parameters: the velocity of the weight or of the fluid contained in the cavity and the area S2 of the weight. Any risk of a landslide resulting from a severe surrounding vibration can then be avoided.

A landslide is a collapse or a fall of the cavity. In case the cavity is a deserted or no longer used mine shaft, this phenomenon may occur. This phenomenon is a sudden and brutal separation of a natural or artificial structure involving the fall of materials making up the cavity.

The cavity (2) according to the invention has a main vertical circulation axis YY′ and contains at least two fluids F1 and F2, with a density of D1 and D2 respectively, such that D1 is much less than D2. Both fluids F1 and F2 are distributed in the cavity so as to occupy volumes V1 and V2 respectively, corresponding to heights H1 and H2 respectively of fluids F1 and F2 in the cavity (2).

Generally the density D1 of the first fluid F1 is less than 0.02 and the density of the second fluid is between 0.9 and 1.1. Ideally the fluid F1 is air and the fluid F2 is water.

By definition, the specific gravity or relative density of the weight is the ratio of its density (mass of a unit volume) to the density of a given reference substance. The reference substance is generally pure water at 4° C. for liquids and solids.

According to the invention the density of the weight is determined with respect to the density of the fluids contained in the cavity (2), so that said weight is denser than said fluids for easier lowering in the cavity (2) without changing the gain of electric power production in the network (1).

‘Compact’ means a structure consisting of a block of materials closely tightened to each other and very difficult to separate.

According to the invention, the weight is composed of a block of one or more various materials closely linked and/or tightened to each other and very difficult to separate.

The circulation cavity of the device according to the invention is built with a reinforced concrete structure or an attached structure being closed on itself.

According to other specifications of the invention, the cavity (2) can be a mine shaft coated with reinforced concrete or any other materials giving it a solid and compact structure that can withstand a shock of very high energy, like the maximum energy corresponding to the free fall of the weight. The cavity (2) can be fitted with pipes. These pipes can be solid or drilled. In some cases, the wall of the cavity (2) can be reinforced by a layer of resilient material, preferably elastomer.

In the case of an idle mine shaft or any other bored well, the cavity can be cut into a solid rock and possibly reinforced by steel or brick or concrete coating or metal casing or any other type of material having good physical properties as defined previously, such as resistivity, density and strength.

Following the explanation or design previously defined, it is clear that the cavity (2) is designed and/or reinforced with materials of special structures as defined above, which can resist, whatever the circumstances, a shock of high energy corresponding to the maximum energy released when the weight falls in the cavity (2).

A seismic study has been conducted to evaluate potential consequences, i.e. destruction of the device and/or walls and/or bottom of the cavity (2) and the propagation of seismic waves generated by the shock of the weight against said cavity in the event of malfunction or collision of the weight with the wall of the cavity (2). This study reveals that the cavity (2) must be designed with walls that can store the whole energy of the weight fall in case of malfunction. As mentioned in the previous section, the cavity (2) is designed with a structure including tight walls capable of withstanding a shock of very high energy corresponding to the maximum energy released when the weight M falls in the cavity (2).

Moreover, in some cases, the cavity (2) comprises a block (4) of materials, preferably resilient materials. This block (4) forming the bottom of the cavity (2) known as the lower part P1, can store the whole energy released when the weight falls in the cavity (2). Thereby, in case of malfunction and/or excessive speed and/or when approaching the lower part P1 forming the bottom of the cavity (2), the weight may hit the internal wall of the cavity (2) without damaging the cavity, thus avoiding a potential earthquake in the region where the device is used.

Advantageously, the cavity (2) has a characteristic traveled dimension d of at least 1 meter, preferably 6 meters or 10 meters.

A study on fluid frictions has defined two significant safety parameters: the safety factor Q and the braking coefficient J. This study has also defined a nominal operation velocity for the storage device according to the invention.

Empirically, in the circulation cavity (2) containing a fluid F1 and/or F2, fluid friction forces are defined by the following relation:

$$f = \frac{1}{2} ρ \times {C}_{x} \times S 2 \times {V}_{r}^{2}$$

where Cx is the drag coefficient, p is the specific gravity of the fluid F1 and/or F2 in the cavity (2) and Vr is the velocity of the fluid relative to the weight in said circulation cavity (2), S2 being defined previously.

When the weight is inserted in the cavity (2) to produce a given power, turbulence appears between the weight M and the fluid F1 and/or F2 involving a significant increase in the fluid friction forces in said cavity (2). Under these conditions, the velocity of the fluid Vr relative to the weight is a function depending on three parameters: the weight velocity, the fluid velocity and the capacity or volume of the fluid F1 and/or F2 in the cavity (2).

From flow rate conservation relations, we can determine the safety factor noted Q. This safety factor is defined as the ratio of the fluid friction forces to the load of the weight M. It particularly depends on two parameters: the velocity V of the weight M within the cavity (2) and the braking coefficient J, such that Q=Q (V,J). The braking coefficient J is defined as the ratio of section S2 of the weight M to section S1 of the cavity (2).

After some iterations of mathematical calculation, the safety factor is then written as follows:

$$Q = Q ( V , J ) = constant \times \frac{{V}^{2}}{{( 1 \cdot J )}^{2}}$$

The constant defined here generally depends on the density of the fluid F1 and/or F2, the drag coefficient Cx, the weight size, the weight density and the gravitational constant; Cx generally depends on the geometry of the weight.

FIG. 4a shows variation curves of the safety factor Q (J) vs. the braking coefficient J for speeds V of the selected weight M. The safety factor Q is defined as the ratio of friction forces F1 and/or F2 to the load of the weight M. Remember that the braking coefficient J is defined as the ratio of section S2 of the weight M to section 1 of the circulation cavity (2). These curves show that an increase in the velocity V of the weight M leads to an ascending slope of the curve indicating the variation of the safety factor Q (J) with respect to the braking coefficient J.

According to the invention, the ideal case is where the device is operating normally without stress. In this ideal case, the safety factor Q (V,J) is less than 1 for a given velocity V of the weight and the braking coefficient J is also less than 1, because, in practice, the safety factor Q (V,J) or the braking coefficient J cannot be greater than 1. When the safety factor Q (V,J) is close to 1 or tends to 1, turbulence is much more important and the device cannot operate, because the movement of the weight M is slowed down by the surrounding fluid friction forces. Similarly, when the braking coefficient J is close to 1 or tends to 1, the weight cannot be included in the cavity, because its section is nearly equal to the cavity section.

In other words, when the safety factor Q (V,J) tends to 1 or approaches the value Q=1, frictions, especially fluid frictions, are getting more and more important and may have adverse effects on the movements of the weight M. Indeed, fluid friction forces can influence the path and/or movement of the weight within the cavity, which leads to harmful consequences on the gain of electric power production in the network and on safety measures required for smooth operation of the storage device according to the invention. It is therefore expected that the weight has a special shape that reduces all kinds of friction forces capable of affecting its movement and/or path. This special shape has good aerodynamic and hydrodynamic properties, especially low hydrodynamic and aerodynamic coefficients: drag coefficient, lift coefficient and drift coefficient.

To prevent these fluid friction forces, which may be important in some cases, from affecting significantly the path and/or movement of the weight M, the weight is designed with an adequate hydrodynamic or aerodynamic shape so that hydrodynamic and/or aerodynamic frictions applied to the weight M by the fluid F1 and/or F2 contained in the cavity (2) are generally negligible and so that the fluid F1 and/or F2 contained in the cavity (2) can flow freely without generating significant adverse forces, especially friction forces, when the weight M moves in the cavity (2). Indeed, when the weight moves in the cavity (2), it behaves like a mobile moving in an environment where hydrodynamic and/or aerodynamic forces are important, generating a turbulent flow. It is then useful to define a particular shape for the weight. Thus, the contact surface or the front surface of the weight must be smaller than the rear surface of the weight. Typically, the front of the weight may be conic or ovoid. In other words, aerodynamics and/or hydrodynamics plays an essential role on details such as the front or rear or edges of the weight M, where the drag coefficient can be considerably reduced by choosing a conic or round shape at the front, as it can be seen on FIGS. 4c to 4j.

According to the invention, weight shapes are chosen so that the weight has a low resistance to the viscous liquid. Indeed, the previously selected shapes have no flat faces and right angles which strongly slow down the weight when it is lowered in the fluid. In other words, lowering of the fluid is much quicker. It is then clear that the weight must be designed with an appropriate hydrodynamic and/or aerodynamic shape so that the fluid F1 and/or F2 contained in the cavity (2) can flow freely without impeding movements of the weight in this cavity. The selected weight profile has an aerodynamic and/or hydrodynamic coefficient smaller than 0.4, preferably 0.04 approximately.

Advantageously, the weight has an ovoid profile with rounded edges.

According to other specifications of the invention, the front portion of the weight is rounded or conic. Indeed, this shape involves fewer frictions in a fluid than a cubic weight M, and therefore a low hydrodynamic and/or aerodynamic coefficient.

According to the invention, the typical profile of the weight M is modelled on the shape of a drop of water: the front is a kind of half-sphere or a cone which has an aerodynamic and/or hydrodynamic coefficient equal to 0.04.

Considering the structure and shape of the weight and calculations written on FIGS. 4a and 4b, the braking coefficient J, defining the ratio S2/S1, is adjusted so that friction forces between the weight M and at least one of the fluids F1 and/or F2 are less than 0.7 of the load of the weight M, when the device according to the invention operates normally, i.e. the safety factor must be smaller than 0.7. Thereby, the fluid F1 and/or F2 can move freely in the cavity (2) without impeding movements of the weight in this cavity.

This braking coefficient J is also adjusted so that friction forces between the weight M and at least one of the fluids F, F1 and/or F2 are greater than 0.7 of the load of the weight M in case of malfunction and/or excessive speed and/or when approaching the lower part P1 forming the bottom, i.e. the safety factor Q must greater than 0.7. Preferably Q tends to 1 in case of malfunction and/or excessive speed. Actually, when Q tends to 1, fluid friction forces can be balanced with the load of the weight M, and the weight is stopped in the cavity (2) without damaging the storage device according to the invention. Similarly, when the safety factor Q is greater than 0.7, friction forces become important and actively slow down the weight in the cavity in case of a malfunction.

FIG. 4b shows variation curves of the safety factor Q (V) vs. velocity of the weight M in the circulation cavity (2) for a selected braking coefficient. These curves show that this safety factor Q (V) varies like a polynomial function, preferably of the second degree. They also show that an increase in the weight velocity involves an increase in the safety factor Q (V). Accordingly, it is necessary to control and/or limit the weight velocity when it falls in the cavity (2), in order to prevent friction forces from growing and affecting the movement of the weight M.

The safety factor Q=Q (V,J) is then a function with two variables: the weight velocity V and the braking coefficient J. This function Q=Q (V,J), which defines the operating conditions (normal or abnormal) of the energy storage device according to the invention, is the combination of two variables, the weight velocity V and the braking coefficient J, for a characteristic traveled dimension d of the cavity (2) of at least 1 meter, preferably 3 meters or 10 meters.

FIG. 4b also shows that, for a braking coefficient J greater than 0.5 corresponding to a velocity V of 9 m/s, the safety factor Q (V,J), representing the pair V and J, is nearly equal to 1. For a braking coefficient J of 0.35 corresponding to a velocity equal to 14 m/s, the safety factor Q (V,J) is almost equal to 1 too. It is clear that the higher the braking coefficient J, the stronger the friction forces. This formulation clearly defines an operating mode in which the device according to the invention will operate normally, because records of the braking coefficient J and the velocity V of the weight are combined. A normal operating mode is chosen from theoretical calculations, not specified here, by taking into account the profile or the hydrodynamic and/or aerodynamic shape of the weight and any kind of constraints that may affect the weight movement. This normal operating mode includes three inter-dependent parameters: the weight velocity V, the braking coefficient J and the safety factor Q (V,J) representing the pair Q (V) and Q (J). Let Q1=Q(J) representing the measurements according to FIG. 4a and Q2=Q(V) representing the measurements according to FIG. 4b. To safely determine normal and abnormal operating conditions of the device according to the invention, we consider a matrix Q (V,J) composed of items Q1 and Q2 which respectively correspond to the measurement of the safety factor for each constant value of V and the measurement of the safety factor for each constant value of J.

A safety factor Q is determined for each pair of measurements (Q1, Q2) of the matrix Q (V,J). This factor represents the coupling reflecting the measurement in which it is likely that the pair of measurements (Q1, Q2) will be a pairing corresponding to proper or wrong operation of the storage device according to the invention. In this way, it is possible to choose a value of Q corresponding to a secure normal operation and the other parameters such as V and J will be adjusted accordingly: this is a one-to-many relationship. Conversely, J and V can be chosen and Q will be adjusted accordingly: this is a many-to-one relationship. The safety factor Q=Q (V,J) defining normal and/or abnormal operation, is then many-to-one or one-to-many or many-to-many, for a characteristic traveled dimension of at least 1 meter, preferably 3 meters or 10 meters. The fact that Q is many-to-one or one-to-many or many-to-many increases the amount of available information to define or ensure proper operation of the energy storage device according to the invention, because all possible combinations of the various values for V and J are taken into account to define a normal and optimal operating mode. It also informs and/or warns the operator and/or triggers another diagnosis defined hereafter in the event of a malfunction as detailed above by considering the value of Q, i.e. less than 0.7 in normal operation or greater than 0.7 in abnormal operation, preferably tending to 1.

According to the invention, the braking coefficient J is less than or equal to 0.4, the weight velocity is less than 6 meters per second and the safety factor is however less than or equal to 0.7. Selection of this pair of values is based on a many-to-one or one-to-many or many-to-many relationship, so that fluid friction forces are generally negligible, i.e. the safety factor Q as a many-to-one or one-to-many or many-to-many function must be less than 0.7 in normal operation for a characteristic traveled dimension of at least 1 meter.

An average velocity less than the selected value 6 m/s allows normal operation of the device with a good gain of power production; but for better safety a velocity less than or equal to 5 meters per second is preferably chosen. Actually, when the velocity is greater than 6 meters per second, the safety factor Q (J) can, in some cases, tend to 1 for a braking coefficient of about 0.4 as shown on FIG. 4a. This operation mode can be detrimental to the weight movement in the cavity (2). That is the reason why a braking coefficient smaller than 0.4 has been selected in normal operation.

The fact that the weight is maintained at a velocity V less than 6 m/s prevents the safety factor Q from tending to 1 in case of malfunction. In the case of a malfunction where the weight M has reached an excessive velocity greater than 6 meters per second, the safety factor tends to 1. Thereby the weight is slowed down in the lower part of the cavity (2) to securely rest, with an appropriate velocity corresponding to the minimum energy the cavity (2) could support.

Similarly, selection of the values for the velocity and braking coefficient J and safety factor Q is based on the principle of a many-to-one or one-to-many function Q (V,J) and ensures smooth operation of the storage device according to the invention.

Formally, the safety factor must not be greater than 1, which explains the selected limit on FIGS. 4a and 4b. Actually, beyond Q=1, several physical phenomena appear and it is difficult to study the aerodynamics and/or hydrodynamics of the storage device according to the invention.

Advantageously, since the safety factor Q corresponding to the normal or abnormal operation of the energy storage device is many-to-one or one-to-many or many-to-many, the safety factor Q is less than a predefined value Qmin in normal mode and less than a value greater than Qmin in abnormal mode.

Referring to FIG. 3, the circulation cavity (2) further comprises a piece of section S3 in the lower part of this cavity (2), on a height H3. This piece of section S3 in the cavity (2) is intended to stop the weight in case of malfunction and/or excessive speed and/or when approaching the lower part P1. Indeed, section S3 is smaller than section S1. Therefore, the braking coefficient J1 corresponding to the ratio of section S2 to section S3 (S2/S3) must be greater than 0.7, preferably less than or equal to 0.9, in order that the fluid slows down the weight by increasing the safety factor Q=Q (V,J1). In this case, the safety factor Q tends to 1.

This piece of section S3 increases fluid friction forces in the circulation cavity (2) or in this portion of the circulation cavity (2), causing a significant drop in the velocity of the weight M in this portion of the cavity (2). Consequently, the weight M is slowed down by the fluid F1 and/or F2 and can rest securely in the lower part P1 forming the bottom, with an almost zero speed.

The piece of section S3 is made of a material or concrete or elastomer or even of the same material as the cavity (2). Said piece of section S3 is inserted into the cavity (2) by means of a suitable groove or another means used to slide it properly until the bottom of the cavity (2) as shown on FIG. 3.

According to the invention, the structure design of this piece of section S3 previously defined is adapted so as to withstand a shock of high energy corresponding to the maximum energy of the weight M in the cavity (2). It also acts as a coating of the cavity (2), which fulfils two functions: protection against intense shocks and braking.

According to an alternative configuration, the whole cavity (2) can be reinforced by the piece of section S3 throughout its length.

According to a configuration of the invention, the weight M and the piece of section S3 includes one or more grooves for directing and/or guiding the weight M into the said piece of section S3 and the piece of section S3 into the cavity (2). In this way, the weight M can easily and securely slide on the portion of the cavity (2) of section S3 to safely end its stroke with an almost zero speed on the lower part P1 forming the bottom of the cavity (2).

In order to improve safety conditions in the lower part of the cavity (2), the braking coefficient J1 corresponding to the ratio S2/S3 is adjusted so that the friction forces between one of the fluids F1 and/or F2 within the lower part and the weight M are strong enough in case of malfunction and/or excessive speed and/or when approaching the lower part P1 forming the bottom. That is to say the safety factor Q must tend to 1. Thereby, the weight M is slowed down before reaching the lower part P1. Under these conditions, the fluid friction forces will act as a brake or backmoving force for preventing the weight M from touching the lower part P1 forming the bottom of the cavity (2) with an excessive speed.

Referring to the previously developed calculation, the brake indices J1 and J express the same thing at different depths or locations in the cavity (2).

In case of malfunction, e.g. when the cable breaks, the weight velocity may be very excessive, for example greater than 9 meters per second. Under these conditions, the weight M can have a significant power enough to destroy the lower part forming the bottom P1 or even cause an earthquake in the surroundings of the storage device, which may become unusable in the future. Thereby, the lower part of the cavity is expected to be made of a material resisting high energies corresponding to the maximum energy released by the weight falling in this lower part forming the bottom P1.

The lower part P1 forming the bottom is also reinforced by a block (4) of materials or elastomer, to avoid any damage of the lower part P1 forming the bottom in case of malfunction and/or excessive speed of the energy storage device according to the invention.

Referring to FIG. 4c or FIG. 4d showing a longitudinal section of the device according to the invention, the lower part P1 forming the bottom comprises a block (4) made of resilient materials like elastomer or of hard materials like concrete. This block (4) is fitted with holes to control fluid circulation when the weight M comes close to the lower part P1 forming the bottom of the cavity (2). This lower part P1 forming the bottom is a block of the previously defined material or a concrete block placed at the bottom of the cavity (2). These material blocks (4) are removable in the cavity (2) and are fitted with holes for draining off the fluid F1 and/or F2 when they are installed in the circulation cavity (2) and when the weight M comes close to the lower part P1. These appropriate materials have mechanical and thermodynamic properties suitable for the maximum energy released when the weight falls in the cavity (2), so that they can store the entire power of the weight M during its free fall in the cavity (2).

In the alternative configuration of FIG. 4c, the material block (4) making up the lower part P1 forming the bottom of the cavity (2) may have one or more grooves or a braking coefficient tending to 1, which allows easy installation of the block on the bottom of the cavity (2). This means that the section of the block (4) is quite equal to the section S1 of the cavity (2).

In the alternative configuration of FIG. 4d, the cavity (2) comprises at least two blocks made of a resilient material and resilient suspension means (5). The blocks (4) together with the resilient suspension means (5) form an anti-vibration and/or shock absorbing resilient suspension system. This suspension system contains one or more resilient blocks (4), e.g. elastomer blocks, and one or more shock absorbers like piston-type dampers and/or spring shock absorbers. As shown on FIG. 4d, shock absorbers are inserted between two rubber or concrete blocks (4). These blocks are installed on the bottom of the cavity (2) by means of bearings allowing easy slide of the block within the cavity, or by means of any other equipment. These bearings can be wheels or grooves. Thereby, in the event of cable break and/or malfunction and/or excessive speed, blocks (4) may absorb the maximum power corresponding to the fall of the weight within the cavity (2) or onto the bottom of the cavity (2).

Both alternative configurations previously defined according to the invention, mainly the device of FIG. 4c and/or 4d, have the advantage of efficiently or completely exclude potential damage of the bottom of the cavity (2) and possible propagation of seismic waves resulting from the collision of the weight M with the bottom P1 and/or walls of the cavity (2), especially in case of malfunction and/or excessive speed. Actually, the block (4) and suspension means (5) absorb forces generated by the collision of the weight M with the lower part forming the bottom of the cavity (2), and then store seismic waves and/or the maximum energy released by the weight fall within the cavity (2), by reducing seismic probabilities considerably.

According to other specifications of the invention, the device of FIG. 4c or FIG. 4d can also include a piece of section S3, not displayed, located in the lower part of the cavity (2) like on FIG. 3, on a height H3. This piece of section S3 of the cavity (2) is intended to slow down the weight in case of malfunction and/or excessive speed and/or when approaching the lower part P1.

Advantageously the device on FIG. 4c and FIG. 4d can operate normally and securely with or without the piece of section S3.

Another alternative configuration according to the invention is shown on FIGS. 4e, 4f, 4i and 4j. In this alternative, the weight M is fitted with at least a port (6) and a tool (7). The tool (7) is removable and can move freely along the ZZ′ axis on a portion of the port (6) by means of bearings or any other means, and form an angle BETA greater than or equal to 5 degrees with the horizontal axis XX′.

When the weight M moves down within the cavity (2), the fluid F1 and/or F2 can flow freely into the lower part (point B) of the weight M through the port (6).

In normal operation, according to the laws of hydrodynamics and/or aerodynamics, the pressure at point A noted PA is quite equal to the pressure at point B noted PB; the safety factor Q is preferably smaller than 0.7; the braking coefficient and the velocity of the weight M are adjusted to the selected value of the safety factor.

When the velocity V of the weight M is zero, the pressure on the top part A is almost equal to the pressure on the lower part B. In case of excessive speed and/or malfunction and/or penetration of the weight M into a denser fluid, the pressure PB at point B changes and is preferably greater than the pressure PA at point A. Since the pressure change is proportional to the velocity of the weight M, the fluid in the cavity pushes the tool (7) outside the weight M, which increases the safety factor Q and the braking coefficient J and reduces the velocity of the weight. In this way, the weight M is slowed down and/or stopped securely in the cavity (2).

During deceleration of the weight M in the cavity (2), the pressure PA at A can be almost equal to the pressure PB at B and the tool (7) can return to its initial state in the port (6). Thus, the weight M can securely stay on the lower part P1 of the cavity (2) or continue to generate electric power with a nominal speed corresponding to the normal operation of the device according to the invention.

The advantage of this alternative configuration lies in that a hydromechanical or hydroelectromechanical system allows the weight M to adjust its movement depending on the safety factor Q of the environment, the velocity of the weight M and the fluid F1 and/or F2. This hydromechanical or hydroelectromechanical system is composed of the tool (7), the port (6) and the fluid F1 and/or F2. The tool (7) is moved by a thrust exerted by the fluid.

Similarly, another alternative configuration of the invention is shown on FIG. 4g and FIG. 4h with the same objective as that of FIGS. 4e, 4f, 4i and 4j, except that the weight M comprises at least a port (6) fitted with a tool (7), this port being placed in the upper part of the weight M and with no direct link to point B. Opening and closure of the tool (7) are governed by two pressure sensors placed at points A and B.

According to other specifications of the invention, the weight also comprises a pressure sensor, a sensor for measuring velocity and/or altitude. The advantage of this alternative is that the hydroelectromechanical system previously defined contains on-board means attached to the weight M; said means can be actuated by various controls allowing operation of the energy storage device according to the invention.

According to other specifications of the invention, the energy storage device is equipped with at least one or more cables C linking the weight M to one or more drums T. The cable C is wound around the drum T. The drum T has a fixed axis of rotation XX′ relative to the cavity, not shown here. In this case, the drum is maintained fixed by a locking system which prevents the weight from moving. The weight can also be placed on the floor to keep the weight at rest with no power consumption.

According to other specifications of the invention, the energy storage device comprises at least a first unit fitted with a locking and unlocking system for the drum T; said first unit maintains the weight in a stable position within the cavity (2) and/or on the platform P2 of the cavity (2) for a given time, as long as desired, at a given altitude, without loss of potential energy and energy consumption. This first unit is perfectly environment-friendly, i.e. it does not emit greenhouse gases, because it does not use a technique releasing carbon dioxide in the air.

Advantageously, said energy storage device further contains at least a second unit which increases the altitude of the weight M along the main circulation axis Y′Y, when the electric power of the network is abundant and available, by converting the electric power of the network into gravitational potential energy. This second unit is also perfectly environment-friendly without greenhouse gas emissions. This second unit includes at least an electric motor ME that converts electric power from the network (1) into gravitational potential energy by driving the drum T. Thereby, the altitude of the weight M increases when the electric power is abundant and available.

Advantageously, the device according to the invention also comprises a third unit that decreases the altitude of the weight M along the main circulation axis YY′ when the network needs electric power, by converting the gravitational potential energy of the weight M and possibly its kinetic energy into electric power. The gravitational potential energy of the weight M and even the kinetic energy thus converted are delivered to the network. This third means is also perfectly environment-friendly without greenhouse gas emissions. This third unit comprises at least a generator GE mechanically connected to the drum T, which both controls velocity of the weight M and supplies the network with the required useful electric power. To adjust the rotation speed of the drum to the rotation speed of the generator, the generator is mechanically connected to the drum via a gear train. This ensures secure control of the weight velocity and redistribution of electric power to the network.

According to other specifications of the invention, the energy storage device includes a forth unit for measuring the altitude of the weight M at least when the weight M is near to the lower part P1 forming the bottom of the cavity (2). This unit is very useful, because it prevents the weight M from reaching the bottom with too high or excessive speed. It also avoids accidents or incidents due to poor conditions at the bottom of the circulation cavity (2). The total mass subjected to acceleration of gravity may be deduced from the knowledge of the weight altitude. Actually, the cable mass is not always negligible relative to the mass of the weight M, especially when the weight M is in a position close to the bottom. The total mass (mass of the weight M+vertical mass of the cable) then increases as the weight goes down in the cavity.

The device according to the invention also comprises a fifth unit which controls in real and delayed time the first, second and third units mentioned above, depending on the quantity and availability of the electric power on the network, the electric power required by the network and the altitude of the weight M. This fifth control unit includes a computer capable of translating instructions used to define:
In the first fluid, the initial time T0 at which the first unit will be actuated and at least a weight M will be released, the acceleration time TCL1 for at least one weight M, the power redistributed to the network from time T1 to the end of acceleration, the time TVC1 during which the lowering speed will be controlled by the third unit to get a speed suitable for the power required by the network, the deceleration time TVD during which the speed of at least one weight M will be adjusted to safely cross the second fluid F2;
In the second fluid F2, the acceleration time TCL2 of at least one weight M in the second fluid, the time TVC2 during which the lowering speed will be controlled by the third unit to reach a speed suitable to the power required by the network in the second fluid, the time TF necessary to reset the said speed to zero.

We prove that the required acceleration time (in seconds) is substantially equal to the ratio of the required power in Watts divided by 80 times the mass of the weight M expressed in kilograms. This relation must be weighted by the influence of the height of the cavity, the influence of frictions and the inertia of pulleys.

For example, for a 1,000 m high well including a weight with a mass of 10⁶ kg, the acceleration time TCL1 and/or TCL2 must be about 1.2 s to provide a mechanical power of 100 MW to the generator.

According to other specifications of the invention, the device also comprises an energy storage battery with very fast release; this battery is placed between the generator and the network and provides energy to the network during a latency time TCL1 and/or TCL2. This latency time is the time necessary for at least one weight M to reach the desired velocity V in the first fluid F1 and/or V′ in the second fluid F2. As defined above in normal operation, the velocity is less than 6 m/s. This velocity is selected to get optimal safety measures.

The device according to the invention also comprises a sixth on-board unit attached to the weight M; it contains electronic and/or electromagnetic detection means and securely detects, in real or delayed time at some meters far from the weight M, the different positions of the weight M during its lowering and/or lifting in the cavity (2). This sixth unit also identifies obstacles and/or variations in density and/or pressure of the fluid F1 and/or F2 and/or the velocity of the fluid F1 and/or F2 relative to the weight M and locally restrains the movement of the weight M within the cavity (2).

The previously defined detection means also reduce and control the velocity of the weight M during the passage from the fluid of density D1 to the fluid of density D2 and vice-versa, i.e. during the passage from the fluid of density D2 to the fluid of density D1, to ensure that the change of the medium is done smoothly, avoiding any inclination or inversion of the weight M. Thus, the device can operate securely in a complex environment composed of at least two fluids, like water and air for example, without impeding the movement of the weight M in the cavity (2). Thereby, the power can be adjusted to the needs of the network.

Advantageously, the cavity (2) can be a deserted mine shaft, adapted to the conditions defined above for this energy storage device according to the invention.

FIG. 5 shows the different movements and lowering steps of the weight M corresponding to a special configuration, defining an operating method for the energy storage device according to the invention. The various movements of the weight M are controlled by the fifth unit and/or the sixth unit.

At initial time T0, the weight M is idle and is maintained in a stable position by the first unit, e.g. on the platform P2 of the cavity (2), at a given altitude, without loss of energy. At time T0, as soon as or slightly before the network requires electric power, the first unit releases the weight M with no initial speed at the initial time T0. The weight M is then accelerated by the gravity, especially by its weight during an acceleration time equals to TCL1, where TCL1=T1−T0, until it reaches the desired speed V1, where V1=V, at time T1. During this time TCL1, the weight M has covered a given distance and the electric power increases progressively up to a value PU1, where PU1=PU, at time T1. The acceleration time TCL1 provides the necessary electric power redistributed to the network at time T1.

From time T1 when the weight M has reached a velocity V, the third unit supplies the network with the required electric power until time T2. During time TVC1, where TVC1=T2−T1 is the time elapsed between T2 and T1, the movement of the weight M is controlled at a velocity adapted to provide the electric power required by the network. For example, if the velocity V is constant, then the electric power delivered to the network is constant and vice versa.

Between T2 and T3, the sixth unit detects the second fluid and the movement of the weight is controlled during a period of time equal to TVD, where TVD=T3−T2, so that the velocity at time T3 is adapted to allow the weight to securely cross the second fluid, preferably at a velocity V3 less than V at time T3. The power delivered during this period of time TVD is adjusted to the movement of the weight M and, in the case of loss of power, this loss of power can be controlled so that the power provided to the network remains almost constant during the period of time TVD.

At time T3, the weight safely crosses the second fluid at speed V3 and is accelerated according to the need for electricity of the network (1), by the effect of its weight during an acceleration time TCL2=T4−T3, until it reaches speed V4, where V4=V′ at time T4, preferably V′=V. During time TCL2, the power increases progressively up to PU2, where PU2=PU′ at time T4, preferably PU′=PU.

From time T4, the third unit supplies the network with the required electric power PU′ until time T5. The time elapsed during this period is TCL2, where TCL2=T5−T4. During this period TCL2, the velocity of the weight is adapted so as to provide the electric power required by the electric network, for example if the power requirement is constant, then the lowering speed will be constant and vice versa.

Between T5 and T6, the forth unit and the sixth unit detect the bottom of the cavity (2) and also the section S3 of this cavity (2). The movement of the weight is controlled during a period of time TF, where TF=T6−T5, so that the speed of the weight at time T6 is reset to zero. Thus, the weight M is slowed down and can either securely rest on the lower part P1 forming the bottom or stop in the lower part of the cavity (2).

Finally, when several cycles of electric power generation have been performed and when the power is abundant and available on the network (1), the weight M is lifted back to its starting position.

During the lowering phase of the weight M corresponding to the request for electric energy by the network (1), the motion of the weight M in the first fluid is governed by three types of movement between T0 and T3:
an accelerated movement during time TCL1 between T0 and T1,
a movement adequate to the need of the network for electric power during time TVC1 between T1 and T2,
a movement suitable for sufficient safety conditions to safely cross the second fluid during time TVD between T2 and T3.

In the second fluid, the motion of the weight M is also governed by three types of movement between T3 and T6:
first an accelerated movement adequate to the need of the network (1) for electricity during time TCL2,
then a movement suitable to the need of the network for electric power during time TVC2,
finally a decelerated movement during time TF.

Advantageously, the storage device according to the invention includes between the weight M and the drum T a pulley or a train of pulleys forming a hoist in order to direct and/or reduce the tensile stress in the cable. Moreover, when the electric power of the network is abundant, the weight M is lifted by the second unit until it reaches the starting top position.

The device can also contain a power storage battery with fast release. This battery is placed between the generator and the network and supplies the network with energy during the latency time TCL1 and/or TCL2. This latency time is the time necessary for the weight M to reach the desired velocity V and/or V′.

It may be seen that an economical and very reactive device can be made, with good release efficiency and without loss of energy during storage, which can store a large amount of energy and ensure proper operation during a great number of cycles and which is environment-friendly and does not emit greenhouse gases.

FIG. 6a or 6b show a longitudinal section of a second preferred configuration of the device according to the invention. This device taken as a whole is quite the same as that described in the preceding figures. Similarly, the operating method of this second configuration of the invention is generally the same as that described above. The difference with the device previously described lies in that, in this device, cables and pulley(s) are replaced by at least a fixed toothed rack attached to the internal wall of the circulation cavity (2). The rack is adapted to rotate a cogwheel around a fixed axis relative to the weight M. The cogwheel is connected to a motor and/or a generator placed and attached to the weight M or on the platform. This device further comprises at least a mechanical unit which avoids any inclination or inversion of the weight M. Thus, in case of malfunction and/or excessive speed and/or closer distance between the weight M and the lower part P1, the piece of section S3 prevents the weight M from reaching the lower part P1 forming the bottom of the cavity (2); the weight M is stopped securely without damaging the device according to the invention or without causing a local earthquake, because all seismic waves are stored by the piece of section S3. Indeed, the piece of section S3 is made of materials with good elastic and shock-absorbing properties that can surely overcome a shock of very high energy.

Advantageously, this piece of section S3 can be designed with the same structure or material as for the cavity (2). It can be made of resilient materials like elastomer in order to act as a shock- and vibration absorber. Thus, in case of malfunction and/or excessive speed, the weight M can bounce without damaging the circulation cavity (2) and without reaching the bottom of said cavity (2), thus avoiding the propagation of vibrations that may cause an earthquake.

Advantageously, in the configurations defined above or below, all the means defined above remain unchanged.

According to other specifications of the invention, the storage device includes two racks attached to the internal walls of the circulation cavity (2). Each rack used is adapted to rotate a cogwheel around a fixed axis relative to the weight M. This cogwheel is connected to a motor and/or a generator placed and fastened on the weight M. This device further contains at least one electronic and/or mechanical equipment that synchronizes the movement of cogwheels in order to avoid any inclination or inversion of the weight M.

FIGS. 6c and 6d are longitudinal sections of an alternative of the first two configurations of the energy storage device according to the invention.

Referring to FIG. 6c, the cavity (2) has the shape of a valley or basin, inclined at an angle ALPHA with respect to the vertical axis.

Referring FIG. 6d, the cavity (2) is not a well (or a tower), but a natural or artificial basin adapted to the previously defined safety conditions and standards. This cavity (2), which is a very large natural or artificial basin, is filled with two fluids, such as water and air for example. This is the case of a marine or oceanic trench or a deep lake. The control system and all other instruments associated with the device are located on a floating platform, anchored or put on a neighbouring or stabilized bottom via a dynamic system and the weight M can move as defined in the first preferred configuration or on an inclined plane at an angle ALPHA as defined above.

Advantageously, a piece of section S3 is placed in the lower part P1 forming the bottom of the basin (not shown here). The lower part P1 forming the bottom is modelled by a block of materials (not shown here too). This piece and this lower part P1 forming the bottom are adapted to surely and securely withstand a shock of high energy corresponding to the maximum energy released during the weight fall. This lower part can be designed with the materials or characteristics defined above in the other configurations.

Advantageously, the weight M is placed on a low-friction device like wheels for example, and can move freely on an inclined surface. The weight M can go back to its initial position via another way than the lowering. This option significantly improves a continuous power release.

Advantageously, the angle ALPHA can be between 0 and 85°, but it is between 30 and 80° in a non-limiting way. Thereby, the fall of a mass can generate a sufficient power necessary to meet the energy needs of the network (1).

FIG. 7 is a longitudinal section of a third preferred configuration of the device according to the invention. The device defined by this configuration has the same structure and function features as the previous configurations. It differs from the other configurations in that it comprises a cavity (2) including another cavity (3) of section S4 located in the lower part of the cavity (2). This cavity (3) has a height H4, is fitted with holes with a section greater than 3 square centimeters on its side surface and contains at least a fluid with a density at least less than 1.1. The lower part forming the bottom of this cavity (3) noted P3 is made of materials, especially the previously defined materials, preferably materials capable of storing the maximum energy released by the fall of the weight M within said cavity (3). Preferably, the bottom of the cavity (3) and/or the cavity (3) are made of resilient materials such as elastomer.

For the safety and proper function of the device, a braking coefficient J2 is defined and corresponds to the ratio S2/S4. Referring to the explanations given above for J and J1, the braking coefficient J2, like J1 and J, is adjusted so that the friction forces between one of the fluids F1 and/or F2 in the cavity (3) and the weight M are sufficiently important in case of malfunction and/or excessive speed and/or when approaching the lower part P1 and/or P3, so that the weight M is slowed down before reaching the lower part P1 and/or P3 by draining off a certain amount of fluid F1 and/or F2 through the holes. That is to say the safety factor Q=Q (V,J2) must be sufficiently important, preferably greater than or equal to 1. Thereby, the cavity (3) can resist a shock of very high energy corresponding to the maximum energy released by the fall of said weight M.

Similarly, the sixth on-board unit, attached to the weight M and containing detection instruments, can detect and locally restrain the displacement of the weight M in the cavity (2) and/or in the cavity (3). The weight M can then be slowed down securely in the cavity (3) without damaging the storage device according to the invention and rests securely in the lower part forming the bottom P3 of said cavity (3).

FIG. 8 is a longitudinal section of a forth preferred configuration of the storage device according to the invention. This configuration is the same as the previous configurations. It differs from the other configurations in that the cavity (3) is moving and can move when desired within the cavity (2) without impeding the movement of the fluid F1 and/or F2, while meeting the safety conditions defined in the previous configurations.

Advantageously, the storage device according to the invention is fitted with one or more holes, preferably a hole located in the lower part, having the same function as the holes on the device of FIG. 7. The cavity (3) is floating and held in equilibrium in the cavity (2) in the region where the fluid density is high, especially near the lower part P1, so that the sixth unit can detect it easily. The density of this cavity (3) is adapted so that it can float easily in the fluid F1 and/or F2.

It is advantageous to use this cavity (3), because it is designed to receive the weight at a certain altitude and securely guide it toward the lower part forming the bottom while slowing it down efficiently. Therefore, the lower part P1 forming the bottom can receive a sufficiently low and damped shock, avoiding the damage of the storage device in case of malfunction and/or excessive speed and/or when approaching the lower part P1 and/or P3.

Referring to explanations given previously for J, J1 and J2, the braking coefficient J3 defined as the ratio S4/S1, is adjusted so that the safety factor Q (V,J3) tends to 1 when the weight is not in the cavity (3) of section S4, or is between 0.7 and 1 when the weight M is in the cavity (3) of section S4. Thus, the weight M slowed down in the cavity (3) of section S4 can rest securely in the cavity (3) and then in the lower part P1 and/or P3 forming the bottom of the cavity (2) and/or cavity (3).

The cavity (3) can be made of a dense material or resilient material or foam or any other material having good properties for smooth operation of the storage device according to the invention.

FIG. 9 is a longitudinal section of a fifth preferred configuration of the device according to the invention. The device according to this configuration has the same structure and function features as the previous configurations. This device differs from the previous configurations in that this device comprises several weights M1, M2, M3, etc with equal or different mass. These weights are stored at the top au the circulation cavity (2). These weights are actuated in turn in the same circulation cavity depending on the electric needs of the network (1), which increases the total energy that can be redistributed to the network.

Advantageously the weight contains, as shown on FIGS. 4i and 4j, a bore (8) that stores weights one after the other more efficiently in a linear stack.

Advantageously weights are stored at the top of the cavity (2), especially on the platform in bores or pockets (10) so that they remain stable in case of malfunction or vibrations on the environment surface such as an earthquake. Pockets or bores (10) are made of concrete or elastomer.

According to other specifications of the invention, the weights M1, M2, M3, etc can be actuated simultaneously without collision, thus respecting a latency time between two successive or subsequent weights. This latency time is sufficient for stacking the weights on each other at the bottom of the cavity (2). This simultaneous action increases the power distributed to the network and weights cannot collide with each other during the lowering.

According to other specifications of the invention, the device also comprises at least one or more cavities (2). These cavities (2) are each fitted with control instruments and at least one or more weights. The control instruments of all cavities (2) are coordinated to continuously provide energy to the network and/or a greater power and/or a greater instantaneous energy delivered to the network.

Advantageously all the cavities (2) including at least one weight operate at the same time.

Advantageously cavities (2) including at least a weight operate in sequence.

FIG. 10 or FIG. 12 is a cross section of the sixth preferred configuration of the device according to the invention.

In the preferred configuration of FIG. 10 and/or FIG. 12, the circulation cavity (2) comprises at least three weights M1, M2, M3 of sections S21, S22, S23 respectively. Distances between each other are d12, d13 and d23. These weights can move securely at the same time or with a delay in the cavity (2), meeting all the operating conditions of the device as defined in the previous configurations. Extra safety conditions are added such as the braking coefficient J4 corresponding to the ratio (S21+S22+S23)/S1 and the ratios d12/d, d23/d, d13/d corresponding to the charge exchange coefficients. Parameters J4 and d12/d, d23/d and d13/d are used to adapt the device to the previously defined standards so that the safety factor Q(V,J4) is greater than 0.7, preferably tends to 1 in case of malfunction and/or excessive speed and/or when approaching the lower part. That is to say friction forces between one of the fluids F1 and/or F2 in the cavity (2) are greater than 0.7 of the load of each weight M1, M2, M3. Thereby, weights M1, M2, M3 can be easily slowed down securely without damaging the lower part forming the bottom P1 or the cavity (2). Moreover, a minimum distance d12, d13, d23 is necessary to avoid contact between weights that might destroy the device or lead to malfunction. A safety gap determined by the charge exchange coefficients is also required to prevent the weights from touching the cavity (2) that may result in a destruction of the device or a malfunction or a seismic wave. Preferably, each exchange coefficient is equal to 0.3 or 0.2.

Advantageously, the safety factor Q(V, J4) is less than 0.7 in normal operation, i.e. friction forces between one of the fluids F1 and/or F2 in the cavity (2) are smaller than 0.7 of the load of the weight M.

According to other specifications of the invention, a braking coefficient J5 corresponding to the ratio (S21+S22+S23)/S3 is also adapted so that friction forces between one of the fluids F1 and/or F2 in the lower part of the cavity (2) and the weights M1, M2 and M3 are sufficiently important in case of malfunction and/or excessive speed and/or when approaching the lower part forming the bottom P1, so that said weights M1, M2, M3 are slowed down before reaching the lower part P1. That is to say the safety factor Q(V,J5) must tend to 1 in case of malfunction and/or excessive speed and/or when approaching the lower part forming the bottom P1.

However, in the sixth configuration of the storage device according to the invention, which is a special configuration, a specific method can be implemented in some cases.

According to an alternative configuration of the energy storage device according to the invention, the first weight M1 is dropped at first, the second weight M2 is dropped with a delay delta with respect to the first weight and the third weight M3 is dropped with a delay delta2 with respect to the first weight. Delta and delta2 can vary between 0 and some seconds, so that the device can be controlled to provide an electric power sufficient and necessary to the operation of the network (1). Thus, the total power supplied by this method can be adjusted to the needs of the network (1), for example the total power can remain constant whatever the movement of one weight, such as stop and/or deceleration and/or acceleration and/or regular linear movement.

According to another alternative configuration of the energy storage device according to the invention, the first weight M1 is in the second fluid, its power production is cut in order that it is accelerated until reaching a selected nominal operating velocity. Meanwhile, the electric power is produced by the weights M2 and M3. This choice is supported by the fact that it is more convenient and secure that the three weights do not cross the second fluid at the same time, because friction forces may become more significant.

According to another alternative configuration of the energy storage device according to the invention, when the first weight M1 approaches the nominal velocity, the other two weights M2 and M3 are slowed down till zero speed and only the weight M1 produces the useful electric power for the network needs. When approaching the lower part of the cavity (2) and/or (3) forming the bottom, the weight M1 is stopped and the movement of the weight M2 is accelerated up to a chosen nominal velocity, necessary for producing sufficient electric power. Then the weight M3 moves. In this way, the three weights do the same movements. The movement of the second weight has a delay delta3 with respect to the first weight and the movement of the third weight has a delay delta4 from the first weight and/or second weight. During production of electric energy by the weight M2, the weight M1 is raised and then during the production of the electric power by the weight M3, the weight M2 is raised. Thus the cycle of nominal power production is repeated to ensure smooth operation of the electric network.

According to another alternative configuration of the energy storage device according to the invention, the electric power is generated by weights M2 and M3 with a regulated power in order that a resulting resistive torque compensates for the initial acceleration, which would allow production of electric power with the weight M1. This power is lower than that corresponding to a resistive torque that compensates for initial acceleration. Said power can be increased progressively while maintaining acceleration to a positive value different from zero.

According to other alternative configurations of the invention as shown on FIG. 11, the cavity (2) is also fitted with at least two rails or two slides (10) that are securely attached to the internal structure of the cavity (2) and can be used to move or slide the weight within the circulation cavity.

Advantageously, the weight, preferably each weight, also comprises at least two wheels, which have a rotation axis integral with the weight and can move on at least one rail (10).

According to other specifications of the invention, as shown on FIG. 12, the cavity comprises at last two weights, preferably three weights, and at least two rail supports (11), preferably three rail supports (11), each rail support consisting of two rails (10). By this way, it is possible to slide three weights in the same cavity along different well-defined paths.

According to other specifications of the invention, the device further includes at least 2^{N} cables C of the same or different nature, where N is a natural integer, preferably 16 cables C, connected to at least a lifting beam (12) balancing forces on all cables. Said lifting beam (12) is connected to at least a mechanical locking system (13) that locks or unlocks the weight to or from the lifting beam (12), said lifting beam and/or mechanical system being guided by a unit fitted with at least 2 wheels.

Advantageously, the device further comprises at least a drum T moving on the platform, making possible to support the mass of the weight M, because it is directly distributed on the various cables. The drum T can also move easily and control the various weights. If a cable breaks, the weight can be always maintained by the other cables.

Advantageously, the weight comprises a mechanical fastening system (14) used as a hooking or fastening point to which the weight is attached by means of the mechanical fastening tool (13). Fastening tools can be hooks or any other fastening systems well-known in other mechanical fields.

Advantageously, the weight has a density at least equal to 3 or ranging from 3 to 10, so that it can easily move in the fluid F1 and/or F2.

Advantageously the cavity has a diameter of at least 3 meters or 10 meters.

Another alternative configuration of the invention couples the energy storage device according to the invention with an electric power plant, e.g. a power wind plant at sea. In this configuration, the electricity generated by the offshore or onshore wind plant is amplified by a voltage amplifier or by the storage device, in order to carry sufficient power on a consumption network for the supply of the power grid.

The invention solves the problems stated above by proposing a green device for storing recoverable energy with high overall efficiency, including:
at least a compact and dense weight M, with section S2, having a density of at least 1 and a mass of at least 10,000 kg,
at least a circulation cavity (2), defining a mobility range for the weight M; said cavity (2) has a height H of at least 20 meters, a characteristic traveled dimension d of at least 1 m, preferably 10 m, a section S1 delimiting the internal environment, a lower part P1 forming a bottom, an accessible top part P2 opened to a platform; said cavity (2) has a main axis of displacement YY′ and contains at least one fluid F,
at least one cable C linking the weight M to at least one drum T and at least a first unit comprising a locking and unlocking system of the drum T; this first unit maintains the weight in a stable position inside the cavity (2) or on the platform of said cavity (2), during a given time and at a given altitude, without loss of potential energy,
at least a second unit including at least an electric motor ME, that converts electric power from the electric supply network (1) into gravitational potential energy by driving the drum T; this second unit will increase the altitude of the weight M when the electric power of the network is abundant and available,
at least a third unit consisting of at least an electric generator GE mechanically connected to the drum T, which both controls velocity of the weight M and supplies the network with the required electric power; this third unit will reduce the altitude of the weight M when the network requires electric power, by converting the gravitational potential energy and possibly kinetic energy of the weight M into electric power; the converted gravitational potential energy and possibly kinetic energy will be delivered to the network,
at least a forth unit for measuring the altitude of the weight M, at least when the weight is close to the bottom of the cavity (2),
at least a fifth control unit in real or delayed time, composed of a computer for controlling the first, second and third units mentioned above, depending on the quantity and availability of the network electric power, the electric energy required by this network and the position of the weight M.

It is advantageous that:
the previously defined cavity (2) is designed and/or strengthened with materials of particular and complex structure that can withstand without risk a shock of high energy corresponding to the maximum power released when the weight M falls in said cavity (2),
the weight M previously defined has a suitable hydrodynamic and/or aerodynamic shape so that, in normal operation, hydrodynamic and/or aerodynamic frictions applied to said weight M by the fluid F are generally negligible and thus the fluid F within the cavity (2) can flow freely without interfering significantly with the movement of the weight M in the cavity (2),
the safety factor Q corresponding to normal and abnormal operation of said power storage device is many-to-one or one-to-many or many-to-many; said factor Q is less than a predefined value Qmin in normal mode and less than a value greater than Qmin in abnormal mode,
the cavity (2) has a characteristic traveled dimension d of at least 1 meter, preferably 6 meters or 10 meters.

It is advantageous that:
the cavity (2) contains at least a first fluid F1 and a second fluid F2 with densities D1 and D2 respectively, such that D1 is much smaller than D2; fluids F1 and F2 are distributed in the cavity so as to completely fill volumes V1 and V2 respectively, corresponding to heights H1 and H2 respectively;
the cavity (2) contains in its lower part at least one anti-vibration and/or shock-absorbent resilient suspension system; this system is installed at the bottom of the cavity (2) by means of bearings allowing easy sliding of the system inside the cavity (2) so that, in the event of cable break and/or malfunction and/or excessive speed, the system can absorb the maximum power released when the weight M falls in the cavity (2);
the braking coefficient J is adapted such that the safety factor Q is less than 0.7 in normal operation and/or greater than 0.7, preferably tending to 1, in case of malfunction and/or excessive speed and/or when approaching the lower part P1;
the weight M includes a hydromechanical or hydroelectromechanical system, which contains at least a tool (7) and at least a port (6) placed in the bottom of the weight M, said tool being capable of moving within a portion of the port (6) under the effect of a thrust exerted by the fluid;
the safety factor Q of the environment and the velocity V of the weight M are coordinated with the said hydromechanical or hydroelectromechanical system in order that the weight M can adjust and/or stop its movement depending on the safety factor Q of the environment, the velocity of the weight M and the fluid F1 and/or F2;
the weight is fitted with a bore or a pocket (8);
the platform includes a bore or a pocket (9) necessary for storing masses;
the cavity (2) also comprises a section S3 located in the lower part of the cavity (2), on a height H3, and the braking coefficient J1 is adjusted so that the safety factor Q in section S3 is sufficiently high in case of malfunction and/or excessive speed and/or when approaching the lower part P1, in order to stop the weight M before reaching the lower part P1;
the cavity (2) also comprises another cavity (3) of section S4 located in the lower part of the cavity (2), on a height H4, said cavity (3) containing one or more holes of section greater than 3 square centimeters on its side surface and at least a fluid with a density at least less than 1.1 and/or the braking coefficient J2 is adjusted so that the safety factor in the cavity (3) is sufficiently high in case of malfunction and/or excessive speed and/or when approaching the lower part P1, in order that the weight M is stopped before reaching the lower part P1 by discharging a certain amount of the fluid F, F1 and/or F2 through said holes; the cavity (3) is designed with appropriate and particular materials capable of withstanding without risk a shock of high power corresponding to the maximum energy released when the weight M falls in the cavity (3);
the cavity (3) is removable, comprises a hole in its lower part and can move at the desired time within the cavity (2) without disturbing the flow of the fluid F, F1 and/or F2; said cavity (3) floats in a stable position in the cavity (2), in the region where the fluid density is high, preferably near the lower part forming a bottom P1; said cavity (3) receives the weight at a certain altitude and safely guides it to the lower part P1 forming a bottom while slowing it down effectively.

It is also advantageous that:
the device further comprises at least a sixth on-board unit connected to the weight M, said unit including electronic and/or electromagnetic detection means which, in real or delayed time, a few meters far from the weight M, securely identify the various positions of the weight M during up and down movement, securely identify obstacles and/or changes in density and/or pressure of the fluid F, F1 and/or F2, and/or the relative velocity of the fluid F, F1 and/or F2, with respect to the weight M and locally slow down the movement of the weight M within the cavity (2) and/or cavity (3) and/or said detection means control the velocity of the weight M during the passage from the fluid of density D1 to the fluid of density D2 and vice-versa, to ensure that the change of the medium is done securely.

It is also advantageous that:
the computer of the fifth control unit is capable of translating instructions for defining in the first fluid the initial time T0 at which the first unit will be actuated and at least a weight M will be released, the acceleration time TCL1 for at least one weight M, the power redistributed to the network from time T1 to the end of acceleration, the time TVC1 during which the lowering speed will be controlled by the third unit to get a speed suitable for the power required by the network, the deceleration time TVD during which the speed of at least one weight M will be adjusted to safely cross the second fluid, the acceleration time TCL2 of at least one weight M in the second fluid, the time TVC2 during which the lowering speed will be controlled by the third unit to reach a speed suitable to the power required by the network in the second fluid, the time TF necessary to reset the said speed to zero;
the device further includes an energy storage battery with very fast release; this battery is placed between the generator and the network and delivers energy to the network during a latency time TCL1 and/or TCL2, which is the time necessary for at least a weight M to reach the desired speed V or V′ in normal operation, this speed being less than 6 meters per second.

It is advantageous that:
the device comprises several weights with same or different mass, that are stored at the top of the circulation cavity (2); said weights are actuated in turn in the same circulation cavity (2) depending on the electrical requirements of the network (1), thereby increasing the total redistributed energy and/or the instantaneous power delivered to the network, and/or said device also comprises several circulation cavities (2), each including control instruments and at least one or more weights; said control instruments are coordinated so as to give a shorter response time and/or a higher energy and/or a higher instantaneous power to the network;
the cavity (2) comprises at least 3 weights M1, M2, M3 with sections S21, S22, S33 respectively, separated from each other by the distances d12, d13 and d23, these weights being able to move at the same time or with a delay in said cavity;
the braking coefficient J4 is adjusted so that the safety factor Q in the cavity (2) is greater than 0.7, preferably tends to 1, in case of malfunction and/or excessive speed and/or when approaching the lower part P1 and/or said safety factor is less than 0.7 in normal operation and/or the braking coefficient J5 is adjusted so that the safety factor Q in the said lower part is sufficiently high in case of malfunction and/or excessive speed and/or when approaching the lower part P1, preferably tends to or equals 1, so that said weight M is slowed down before reaching the lower part P1;
the cavity (2) further comprises at least two rail supports (11), preferably three rail supports (11), each rail support (11) including two rails or two slides (10) securely mounted on the internal structure of the cavity (2);
the weight further comprises at least two wheels having an axis of rotation integral with the weight and capable of travelling on at least a rail;
the device further comprises at least 2^{N} cables C, where N is a natural integer, preferably 16 cables C attached to at least one lifting beam (12) balancing the forces on all the cables C, said lifting beam (12) being connected to at least a mechanical locking system (13) for unlocking or locking the weight from or to the lifting beam (12), said lifting beam (12) and/or said mechanical system (13) being guided by a unit fitted with at least 2 wheels;
the device also includes at least a drum T that can move on the platform;
the cavity is a nearly vertical mine shaft or a natural or artificial basin;
the device is coupled with a power plant, e.g. an offshore or onshore wind power plant.

The invention also solves problems stated above by providing a method for storing recoverable electric power with high overall efficiency, taking electric energy from a network (1) when it is abundant and available on this network (1) and redistributing electric power to the network (1) when needed; this method is used to operate the device according to any one of the preceding configurations.

The electric energy storage and release cycle can be controlled according to the following steps:
step a) as soon as the electric energy of the network is abundant and available, the second unit increases the altitude of the weight M along the main axis of displacement or another path by converting the electric energy of the network into gravitational potential energy; if said abundant and available electric energy makes it possible, the weight M is lifted up to its maximum altitude, on the platform P2 for example; thus the weight M has acquired gravitational potential energy that can be further released wholly or partly,
step b) at least a weight M is maintained in a stable equilibrium position by the first unit, for example on the platform P2 of the cavity (2), at a given altitude, without energy loss,
step c) at time T=T0, when the network needs energy, or slightly before, the first unit releases at least one weight M with no initial speed; said weight is then accelerated under the influence of its weight during an acceleration time TCL1 until it reaches the desired speed V1=V at time T1; during time TCL1 the power gradually increases up to the electric power PU1=PU at time T1,
step d) from time T1, the third unit delivers the required electric power PU to the network till time T2; the velocity of the weight is adjusted so as to provide the electric power required by the network; for example, if the request for energy is continuous, then the lowering speed will be constant, since the time elapsed between T2 and T1 is equal to TVC1,
step e) between T2 and T3, the sixth unit detects the second fluid and the weight is moved during a period of time TVD so that the velocity at time T3 is adjusted to allow the weight to safely cross the second fluid, preferably at a speed V3 less than V at time T3,
step f) at time T=T3, the weight safely crosses the second fluid with speed V3 and it is accelerated again depending on the energy needs of the network (1), under the influence of its weight during an acceleration time TCL2 until it reaches a speed V4=V′ at time T4; during time TCL2, the power gradually increases up to the electric power PU2=PU′ at time T4, preferably PU1=PU2,
step g) from time T4 the third unit provides the required electric power PU′ to the network until time T5; the velocity of said weight is adjusted to supply the network with the required power; for example, if the request for power is continuous, then the lowering speed will be constant, since the time elapsed between T5 and T4 is equal to TVC2,
step h) between T5 and T6 the forth unit and the sixth unit detect the lower part of the cavity (2) and/or of the cavity (3) and the weight is moved during time TF so that the weight velocity at time T6 is reset to zero,
step i) when several cycles of electric power generation have been performed and when the power is abundant and available on the network, we go back to step a).

It is advantageous that the said method consists of at least two weights M1, M2, the first weight M1 being dropped at first, the second weight being dropped with a delay delta t relative to the first weight, and that the total power delivered by this method can be adjusted to the needs of the network (1); for example it can remain almost constant regardless of the motion of one of the weights, such as stop and/or deceleration and/or acceleration and/or a regular linear movement and during the lifting of a weight.

It is advantageous that the said method allows the weight M to control and/or stop its movement in case of malfunction and/or excessive speed and/or when approaching the lower part P1 as follows:
in normal operation, pressure PA is nearly equal to pressure PB, the safety factor Q is less than 0.7 and the braking coefficient is adjusted to the safety factor and velocity of the weight M;
when pressure PB is different from pressure PA, preferably greater than pressure PA, and/or when the safety factor Q tends to 1 in abnormal operation, preferably greater than 0.7, the fluid F1 and/or F2 in the hole (6) exerts a significant thrust on the tool (7);
the tool (7) moves out of the hole, leading to an increase in the safety factor Q and the braking coefficient J and/or J1 and/or J2 and/or J3, preferably a braking coefficient less than or equal to 1, followed by a decrease in the velocity of the weight M;
when the weight velocity is back to normal and/or when pressure PA becomes almost equal to pressure PB, the tool (7) returns to its initial position and the weight M can produce a nominal power to the network or safely rests in the lower part P1 forming the bottom of the cavity (2) and/or (3).

Advantageously, during the lowering phase of the weight M corresponding to the request for electric energy by the network (1), the motion of the weight M in the first fluid is governed by three types of movement between T0 and T3:
an accelerated movement during time TCL1 between T0 and T1,
a movement adequate to the need of the network for electric power during time TVC1 between T1 and T2,
a movement suitable for sufficient safety conditions to safely cross the second fluid during time TVD between T2 and T3.

Advantageously, in the second fluid the motion of the weight M is also governed by three types of movement between T3 and T6:
first an accelerated movement adequate to the need of the network (1) for electricity during time TCL2,
then a movement suitable to the need of the network for electric power during time TVC2,
finally a decelerated movement during time TF.

The energy storage device according to the invention uses simple techniques and means. It may be seen that it is possible to produce a device industrially and define a method for storing a great amount of energy when it is abundant and cheap on a network and redistributing it with good response and high power to the network when needed, at low cost and in an environment-friendly way.

Contrary to the idea that we cannot store at little cost great amounts of energy that can be redistributed to the network with good response, the device and method developed in the invention provide a technical solution to the technical problem stated above.

The professionals will be able to apply this invention to many other similar systems without being outside the framework of the invention defined in the claims appended. For example, the cable C can be replaced by a chain or the motor and generator can be combined in a motor-generator comprising an electronic switching system allowing use of coils either in motor mode or in generator mode.

This invention is not limited to the configurations and alternatives described and shown here, but the professional will be capable of bringing any consistent changes.

1) A green device for storing recoverable energy with high overall efficiency, comprising:
at least a compact and dense weight M, with section S2, having a density of at least 1 and a mass of at least 10,000 kg,
at least a nearly vertical circulation cavity (2), defining a mobility range for the weight M; said cavity (2) has a height H of at least 20 meters, a characteristic traveled dimension d, a section S1 delimiting the internal environment, a lower part P1 forming a bottom, an accessible top part P2 opened to a platform; said cavity (2) has a main axis of displacement YY′ and contains at least one fluid F,
at least one cable C linking the weight M to at least one drum T and at least a first unit comprising a locking and unlocking system of the drum T; this first unit maintains the weight in a stable position inside the cavity (2) or on the platform of said cavity (2), during a given time and at a given altitude, without loss of potential energy,
at least a second unit including at least an electric motor ME, that converts electric power from the electric supply network (1) into gravitational potential energy by driving the drum T; this second unit will increase the altitude of the weight M when the electric power of the network is abundant and available,
at least a third unit consisting of at least an electric generator GE mechanically connected to the drum T, which both controls velocity of the weight M and supplies the network with the required electric power; this third unit will reduce the altitude of the weight M when the network requires electric power by converting the gravitational potential energy and possibly kinetic energy of the weight M into electric power; the converted gravitational potential energy and possibly kinetic energy will be delivered to the network,
at least a forth unit for measuring the altitude of the weight M, at least when the weight is close to the bottom of the cavity (2),
at least a fifth control unit in real or delayed time, composed of a computer for controlling the first, second and third units mentioned above, depending on the quantity and availability of the network electric power, the electric energy required by this network and the position of the weight M,
characterized in that
the cavity (2) is designed and/or strengthened with materials of particular and complex structure that can withstand a shock of high energy corresponding to the maximum power released when the weight M falls in said cavity (2),
the weight M has a suitable hydrodynamic and/or aerodynamic shape so that, in normal operation, hydrodynamic and/or aerodynamic frictions applied to said weight M by the fluid F are generally negligible and thus the fluid F within the cavity (2) can flow freely without interfering significantly with the movement of the weight M in the cavity (2),
the safety factor Q corresponding to normal and abnormal operation of said power storage device is many-to-one or one-to-many or many-to-many; said factor Q is less than a predefined value Qmin in normal mode and less than a value greater than Qmin in abnormal mode,
the cavity (2) has a characteristic traveled dimension d of at least 1 meter, preferably 6 meters or 10 meters.

2) A device according to claim 1 characterized in that the cavity (2) contains at least a first fluid F1 and a second fluid F2 with densities D1 and D2 respectively, such that D1 is much smaller than D2; fluids F1 and F2 are distributed in the cavity so as to completely fill volumes V1 and V2 respectively, on heights H1 and H2 respectively.

3) A device according to claim 1, characterized in that the cavity (2) contains in its lower part at least one anti-vibration and/or shock-absorbent resilient suspension system; this system is installed at the bottom of the cavity (2) by means of bearings allowing easy sliding of the system inside the cavity (2) so that, in the event of cable break and/or malfunction and/or excessive speed, the system can absorb the maximum power released when the weight M falls in the cavity (2).

4) A device according to claim 1, characterized in that the braking coefficient J is adapted such that the safety factor Q is less than 0.7 in normal operation and/or greater than 0.7, preferably tending to 1, in case of malfunction and/or excessive speed and/or when approaching the lower part P1.

5) A device according to claim 1, characterized in that the weight M includes a hydromechanical or hydroelectromechanical system, which contains at least a tool (7), at least a port (6) placed in the lower part of the weight M and the fluid F1 and/or F2, said tool being capable of moving within a portion of the port (6) under the effect of a thrust exerted by the fluid, and characterized in that the safety factor Q of the environment and the velocity V of the weight M are coordinated with the said hydromechanical or hydroelectromechanical system in order that the weight M can regulate and/or stop its movement depending on the safety factor Q of the environment, the velocity of the weight M and the fluid F1 and/or F2.

6) A device according to claim 1, characterized in that the cavity (2) also comprises a section S3 located in the lower part of the cavity (2), on a height H3, and in that the braking coefficient J1 is adjusted in order that the safety factor Q in section S3 is sufficiently high in case of malfunction and/or excessive speed and/or when approaching the lower part P1, so that the weight M stops before reaching the lower part P1.

7) A device according to claim 1, characterized in that the cavity (2) also comprises another cavity (3) of section S4 located in the lower part of the cavity (2), on a height H4, said cavity (3) containing one or more holes of section greater than 3 square centimeters on its side surface and at least a fluid with a density at least less than 1.1 and/or in that the braking coefficient J2 is adjusted in order that the safety factor in the cavity (3) is sufficiently high in case of malfunction and/or excessive speed and/or when approaching the lower part P1 so that the weight M is stopped before reaching the lower part P1 by discharging a certain amount of the fluid F, F1 and/or F2 through said holes, the cavity (3) being capable of withstanding without risk a shock of high power corresponding to the maximum energy released when the weight M falls in the cavity (3).

8) A device according to claim 7, characterized in that the cavity (3) is removable, comprises a hole in its lower part and can move at the desired time within the cavity (2) without disturbing the flow of the fluid F, F1 and/or F2; said cavity (3) is floating in a stable position within the cavity (2) in the region where the fluid density is high, preferably near the lower part forming a bottom P1; said cavity (3) receives the weight at a certain altitude and safely guides it to the lower part P1 forming a bottom while slowing it down effectively.

9) A device according to claim 1, characterized in that the device further comprises at least a sixth on-board unit attached to the weight M, said unit including electronic and/or electromagnetic detection means which, in real or delayed time, a few meters far from the weight M, securely identify the various positions of the weight M during up and down movement, securely identify obstacles and/or changes in density and/or pressure of the fluid F, F1 and/or F2, and/or the relative velocity of the fluid F, F1 and/or F2, with respect to the weight M and locally slow down the movement of the weight M within the cavity (2) and/or cavity (3) and/or in that said detection means control the velocity of the weight M during the passage from the fluid of density D1 to the fluid of density D2 and vice-versa, to ensure that the change of the medium is done securely.

10) A device according to claim 1, characterized in that the computer of the fifth control unit is capable of translating instructions for defining in the first fluid the initial time T0 at which the first unit will be actuated and at least a weight M will be released, the acceleration time TCL1 for at least one weight M, the power redistributed to the network from time T1 to the end of acceleration, the time TVC1 during which the lowering speed will be controlled by the third unit to get a speed suitable to the power required by the network, the deceleration time TVD during which the speed of at least one weight M will be adjusted to safely cross the second fluid, the acceleration time TCL2 of at least one weight M in the second fluid, the time TVC2 during which the lowering speed will be controlled by the third unit to reach a speed suitable to the power required by the network in the second fluid, the time TF necessary to reset the said speed to zero.

11) A device according to claim 1, characterized in that said device further includes an energy storage battery with very fast release; this battery is placed between the generator and the network and delivers energy to the network during a latency time TCL1 and/or TCL2, which is the time necessary for at least a weight M to reach the desired velocity V or V′ in normal operation, this velocity being less than 6 meters per second.

12) A device according to claim 1, characterized in that said cavity (2) further comprises at least two rail supports (11), preferably three rail supports (11), each rail support (11) including two rails or two slides (10) securely mounted on the internal structure of the cavity (2) and the weight further comprises at least two wheels having an axis of rotation integral with the weight and capable of travelling on at least one rail.

13) A device according to claim 1, characterized in that it further comprises at least 2^{N} cables C, where N is a natural integer, preferably 16 cables C attached to at least one lifting beam (12) balancing the forces on all the cables C, said lifting beam (12) being connected to at least a mechanical locking system (13) for unlocking or locking the weight from or to the lifting beam (12), said lifting beam (12) and/or said mechanical system (13) being guided by a unit fitted with at least 2 wheels and characterized in that it also includes at least a drum T that can move on the platform.

14) A device according to claim 1, characterized in that said device comprises several weights with same or different mass, that are stored at the top of the circulation cavity (2); said weights are actuated in turn in the same circulation cavity (2) depending on the electrical requirements of the network (1), thereby increasing the total redistributed energy and/or the instantaneous power delivered to the network, and/or said device also comprises several circulation cavities (2), each including control instruments and at least one or more weights; said control instruments are coordinated so as to give a shorter response time and/or a higher energy and/or a higher instantaneous power to the network.

15) A device according to claim 1, characterized in that the cavity (2) comprises at least 3 weights M1, M2, M3 with sections S21, S22, S33 respectively, separated from each other by the distances d12, d13 and d23, these weights being able to move at the same time or with a delay in said cavity, and characterized in that the braking coefficient J4 is adjusted so that the safety factor Q in the cavity (2) is greater than 0.7, preferably tends to 1, in case of malfunction and/or excessive speed and/or when approaching the lower part P1 and/or characterized in that the safety factor is less than 0.7 in normal operation and/or in that the braking coefficient J5 is adjusted so that the safety factor Q in the said lower part is sufficiently high in case of malfunction and/or excessive speed and/or when approaching the lower part P1, preferably tends to or equals 1, so that said weight M is slowed down before reaching the lower part P1.

16) A device according to claim 1, characterized in that the cavity is a nearly vertical mine shaft or a natural or artificial basin.

17) A device according to claim 1, characterized in that it is coupled with a power plant, e.g. an offshore or onshore wind power plant.

18) A method for storing recoverable electric power with high overall efficiency, which takes electric power from a network (1) when it is abundant and available on this network (1) and redistributes electric power to the network (1) when needed, this method being used to operate the device according to claim 9, characterized in that the electric energy storage and release cycle can be controlled according to the following steps:
step a) as soon as the electric energy of the network is abundant and available, the second unit increases the altitude of the weight M along the main axis of displacement or another path by converting the electric energy of the network into gravitational potential energy; if said abundant and available electric energy makes it possible, the weight M is lifted up to its maximum altitude, on the platform P2 for example; thus the weight M has acquired a gravitational potential energy that can be further released wholly or partly.
step b) at least a weight M is maintained in a stable equilibrium position by the first unit, for example on the platform P2 of the cavity (2), at a given altitude, without energy loss.
step c) at time T=T0, when the network needs energy, or slightly before, the first unit releases at least one weight M with no initial speed; said weight is then accelerated under the influence of its weight during an acceleration time TCL1 until it reaches the desired speed V1=V at time T1; during time TCL1 the power gradually increases up to the electric power PU1=PU at time T1.
step d) from time T1, the third unit delivers the required electric power PU to the network till time T2; the velocity of the weight is adjusted so as to provide the electric power required by the network; for example, if the request for energy is continuous, then the lowering speed will be constant, since the time elapsed between T2 and T1 is equal to TVC1.
step e) between T2 and T3, the sixth unit detects the second fluid and the weight is moved during a period of time TVD so that the speed at time T3 is adjusted to allow the weight to safely cross the second fluid, preferably at a speed V3 less than V at time T3.
step f) at time T=T3, the weight safely crosses the second fluid with speed V3 and it is accelerated again depending on the energy needs of the network (1), under the influence of its weight during an acceleration time TCL2 until it reaches a speed V4=V′ at time T4; during time TCL2, the power gradually increases up to the electric power PU2=PU′ at time T4, preferably PU1=PU2.
step g) from time T4 the third unit provides the required electric power PU′ to the network until time T5; the speed of said weight is adjusted to supply the network with the required power; for example, if the request for power is continuous, then the lowering speed will be constant, since the time elapsed between T5 and T4 is equal to TVC2.
step h) between T5 and T6 the forth unit and the sixth unit detect the lower part of the cavity (2) and/or of the cavity (3) and the weight is moved during time TF so that the weight speed at time T6 is reset to zero.
step i) when several cycles of electric power generation have been performed and when the power is abundant and available on the network, we go back to step a).

19) A method for storing recoverable energy according to claim 18, characterized in that it consists of at least two weights M1, M2, the first weight M1 being dropped at first, the second weight being dropped with a delay delta t relative to the first weight, and in that the total power delivered by this method can be adjusted to the needs of the network (1); for example it can remain almost constant regardless of the motion of one of the weights, such as stop and/or deceleration and/or acceleration and/or a regular linear movement and during the lifting of a weight.

20) A method according to claim 18, characterized in that during the lowering phase of the weight M corresponding to the request for electric energy by the network (1), the motion of the weight M in the first fluid is governed by three types of movement between T0 and T3:
an accelerated movement during time TCL1 between T0 and T1,
a movement adequate to the need of the network for electric power during time TVC1 between T1 and T2,
a movement suitable for sufficient safety conditions to safely cross the second fluid during time TVD between T2 and T3.

21) A method according to claim 18, characterized in that in the second fluid the motion of the weight M is also governed by three types of movement between T3 and T6:
first an accelerated movement adequate to the need of the network (1) for electricity during time TCL2,
then a movement suitable to the need of the network for electric power during time TVC2,
finally a decelerated movement during time TF.

22) A method for storing recoverable energy according to claim 18, allowing the weight M to control and/or stop its movement in case of malfunction and/or excessive speed and/or when approaching the lower part P1 as follows:
in normal operation pressure PA is nearly equal to pressure PB, the safety factor Q is less than 1, preferably less than 0.7, and the braking coefficient is adjusted to the safety factor and velocity of the weight M; when pressure PB exceeds pressure PA and/or when the safety factor Q is greater than 1 in abnormal operation, preferably greater than 0.7, the fluid F1 and/or F2 in the hole (6) exerts a significant thrust on the tool (7),
the tool (7) moves out of the hole, causing an increase in the safety factor Q and the braking coefficient J and/or J1 and/or J2 and/or J3, preferably a braking coefficient less than or equal to 1, followed by a decrease in the velocity of the weight M,
when the weight velocity is back to normal and/or when pressure PA becomes almost equal to pressure PB, the tool (7) returns to its initial position and the weight M can produce a nominal power to the network or safely rests in the lower part P1 forming the bottom of the cavity (2) and/or (3).
